(19) United States
(12) Patent Application Publication
(10) Pub. No.: US 2019/0013719 A1
(43) Pub. Date: Jan. 10, 2019

(54) MOTOR

(71) Applicant: ASMO CO., LTD., Shizucka-ken (JP)

(72) Inventors: Kazutoshi Kihira, Kosai-shi (JP); Tetsuaki Ichikawa, Iwata-shi (JP); Akira Shiga, Kosai-shi (JP)

(21) Appl. No.: 15/750,580

(22) PCT Filed: Feb. 9, 2017
(86) PCT No.: PCT/JP2017/004712

§ 371 Date: Feb. 6, 2018

(30) Foreign Application Priority Data
Feb. 22, 2016 (JP) 2016-031271
Mar. 2, 2016 (JP) 2016-040286

(51) Int. Cl. H02K 13/10; H02K 13/00; H01R 39/18; H01R 39/38; H02K 5/14

(52) U.S. Cl. CPC H02K 13/10; H02K 13/006; H02K 5/148; H01R 39/38; H01R 39/18

(57) ABSTRACT

A motor includes a commutator having segments, and feeding brushes which successively come into sliding contact with the segments. One of the plurality of feeding brushes is a first feeding brush with an electric resistance value that varies in a rotation direction of the commutator. The rest of the feeding brushes are second feeding brushes with a constant electric resistance value in the rotation direction. The first feeding brush includes a high resistance portion disposed in a part including a forward end portion of the first feeding brush in the rotation direction, and a low resistance portion arranged side-by-side with the high resistance portion in the rotation direction. The electric resistance value of the second feeding brushes is higher than that of the low resistance portion.

### TECHNICAL FIELD

The present invention relates to a motor.

### BACKGROUND ART

A known motor in which a plurality of power supply brushes slides in contact with a plurality of commutator segments includes at least either a plurality of anode power supply brushes or a plurality of cathode power supply brushes.

Patent document 1 describes an example of a motor including a plurality of anode power supply brushes and a plurality of cathode power supply brushes. The motor is configured so that the power supply brushes having the same polarity are separated from the segments at different timings. The power supply brushes of the same polarity are further configured so that a power supply brush separated from a segment at a later timing has a higher electric resistance than the other power supply brushes having the same polarity. In such a motor, only a power supply brush that is separated from a segment at a later timing produces a spark when separated from the segment. The power supply brush that is separated from a segment at a later timing has a larger electric resistance than the other power supply brush. Thus, the produced spark is smaller than a spark produced from the other power supply brushes (i.e., power supply brushes having smaller electric resistance). This limits the shortening of the life of the power supply brush caused by spark wear.

### PRIOR ART DOCUMENTS

### Patent Document

Patent Document 1: Japanese Laid-Open Patent Publication number 2003-348800

### SUMMARY OF INVENTION

### Problems that are to be Solved by the Invention

The power supply brushes slide in contact with the segments arranged next to one another in the rotation direction of the commutator. Thus, friction or the like that occurs between the power supply brushes and the segments may result in loosening of the power supply brushes in the rotation direction of the commutator. When the power supply brushes are loosened in the rotation direction of the commutator, the distal ends of the power supply brushes may crack when coming into contact with the segments. In such a case, a power supply brush having a smaller electric resistance may be separated from a segment after a power supply brush that has a larger electric resistance and is set to be separated from a segment at a later timing. When the power supply brush having a smaller electric resistance is separated from a segment at later timing than a power supply brush having a larger electric resistance, a large spark may be produced from the power supply brush having the smaller electric resistance. When a large spark is produced from the power supply brush having the smaller electric resistance, the spark may greatly advance wear of the power supply brush having a smaller electric resistance and shorten the life of the power supply brush.

An object of the present invention is to provide a motor that includes a plurality of power supply brushes and limits the shortening of the life of a power supply brush having a smaller electric resistance.

### Means for Solving the Problem

To achieve foregoing objective, one aspect of the present disclosure is a motor that includes: a commutator rotated in a circumferential direction, wherein the commutator includes a plurality of segments and a short-circuiting member, the plurality of segments are arranged next to each other in the circumferential direction, a plurality of coils are respectively connected to the plurality of segments, and the short-circuiting member short-circuits the segments at which potential is the same; and a plurality of power supply brushes that sequentially slide in contact with the plurality of segments. The plurality of power supply brushes are at least either one of a plurality of anode power supply brushes and a plurality of cathode power supply brushes. At least one of the plurality of power supply brushes is a first power supply brush having an electric resistance that varies in a rotation direction of the commutator. At least a remaining one of the plurality of power supply brushes is a second power supply brush that has a constant electric resistance in the rotation direction of the commutator. The first power supply brush includes a high-resistance portion that is defined by a portion that includes a front end of the first power supply brush in the rotation direction of the commutator and a low-resistance portion that is arranged next to the high-resistance portion in the rotation direction of the commutator and has a smaller electric resistance than the high-resistance portion. The second power supply brush has a larger electric resistance than the low-resistance portion.

To achieve foregoing objective, further aspect of the present disclosure is a motor that includes: a commutator rotated in a circumferential direction, wherein the commutator includes a plurality of segments and a short-circuiting member, the plurality of segments are arranged next to each other in the circumferential direction, a plurality of coils are respectively connected to the plurality of segments, and the short-circuiting member short-circuits the segments at which potential is the same; a plurality of power supply brushes including distal ends that sequentially slide in contact with the plurality of segments; a brush holder that includes a plurality of brush holding portions respectively accommodating the plurality of power supply brushes; and a plurality of urging members that respectively urge rear end surfaces of the plurality of power supply brushes toward the commutator. The plurality of power supply brushes are at least either one of a plurality of anode power supply brushes and a plurality of cathode power supply brushes. At least one of the plurality of power supply brushes of the same polarity is a first power supply brush that partially or entirely defines a low-resistance portion arranged in the rotation direction of the commutator. A remaining one of the plurality of power supply brushes is a second power supply brush that has a larger electric resistance than the low-resistance portion. The first power supply brush and the second power supply brush of the same polarity are simultaneously separated from the segments or the second power supply brush is separated from the segment later than the first power supply brush. A rear end surface of the second power supply brush is inclined to direct a vector of an urging force produced by the corresponding urging member toward a front side in the rotation direction of the commutator.

### BRIEF DESCRIPTION OF DRAWINGS

FIG. 1 is an exploded perspective view of a motor according to a first embodiment.

FIG. 2A is a schematic view of the motor in the first embodiment, and FIG. 23 is an enlarged view illustrating a commutator of the motor.

FIG. 3 is a front view of a brush holder in the first embodiment.

FIG. 4 is a schematic diagram of the motor in the first embodiment showing a net in a plane.

FIG. 5 is a schematic diagram of a portion corresponding to the commutator of the motor in the first embodiment showing a net in a plane.

FIG. 6 is a schematic diagram of a portion corresponding to a commutator of a motor according to a second embodiment showing a net in a plane.

FIG. 7 is a schematic diagram of a portion corresponding to a commutator of a motor according to a third embodiment showing a net in a plane.

FIG. 8 is a schematic diagram of a portion corresponding to a commutator of a motor according to a fourth embodiment showing a net in a plane.

FIG. 9 is a schematic diagram of a portion corresponding to a commutator of a motor according to a fifth embodiment showing a net in a plane.

FIG. 10 is a schematic diagram of a motor according to a sixth embodiment showing a net in a plane.

FIG. 11 is a schematic diagram of a motor according to a seventh embodiment showing a net in a plane.

FIG. 12 is a schematic diagram of a portion corresponding to a commutator of a motor according to a different mode showing a net in a plane.

FIG. 13 is a schematic diagram of a portion corresponding to a commutator of a motor according to a different mode showing a net in a plane.

FIGS. 14A and 14B are cross-sectional views each illustrating a power supply brush according to a different mode.

FIG. 15 is a schematic diagram of a portion corresponding to a commutator of a motor according to a different mode showing a net in a plane.

FIG. 16 is a schematic diagram of a portion corresponding to a commutator of a motor according to a different mode showing a net in a plane.

FIG. 17 is a schematic diagram of a motor according to a different mode showing a net in a plane.

FIG. 18A is a schematic view of a motor according to an eighth embodiment, and FIG. 18B is an enlarged view illustrating a commutator and the commutator of the same motor.

FIG. 19 is a partial enlarged view of a brush holder in the eighth embodiment.

FIG. 20 is a schematic diagram of a portion corresponding to a commutator of the motor in the eighth embodiment showing a net in a plane.

FIG. 21 is a schematic diagram illustrating a power supply brush of the motor in the eighth embodiment.

FIG. 22 is a schematic diagram of a portion corresponding to a commutator of a motor according to a ninth embodiment showing a net in a plane.

FIG. 23 is a schematic diagram illustrating a power supply brush of the motor in the ninth embodiment.

FIG. 24 is a schematic diagram of a portion corresponding to a commutator of a motor according to a tenth embodiment showing a net in a plane.

FIG. 25 is a schematic diagram of a portion corresponding to a commutator of a motor according to an eleventh embodiment showing a net in a plane.

FIG. 26 is a schematic diagram illustrating a power supply brush of the power supply brush of the motor in the eleventh embodiment.

FIG. 27 is a schematic diagram of a portion corresponding to a commutator of a motor according to a twelfth embodiment showing a net in a plane.

FIG. 28 is a schematic diagram illustrating a power supply brush of the motor in the twelfth embodiment.

### DESCRIPTION OF EMBODIMENTS

### First Embodiment

A motor according to a first embodiment will now be described.

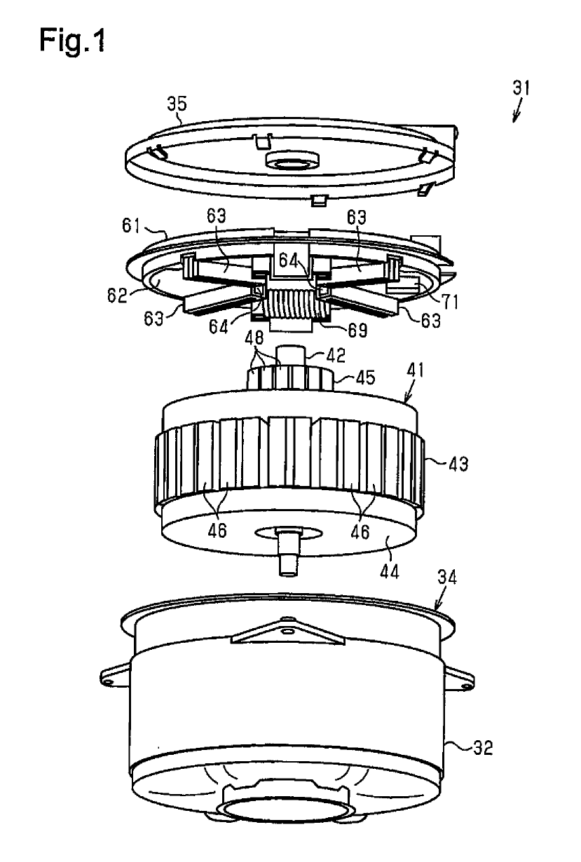

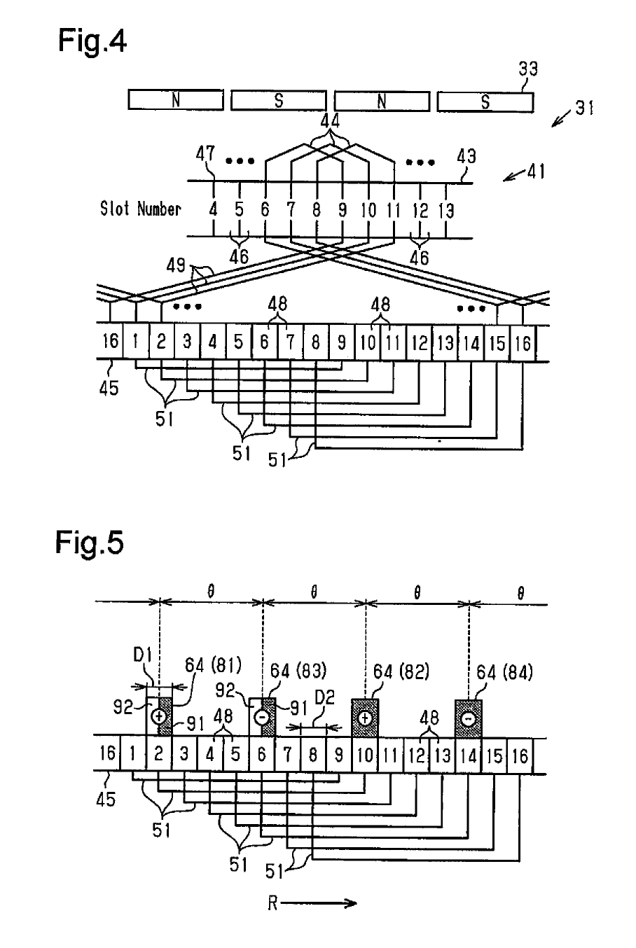

As illustrated in FIG. 1, a motor 31 is provided with a stator 34 including a housing 32, which is cylindrical and has a closed end, and magnets 33 (see FIG. 4), which are fixed to an inner circumferential surface of the housing 32. An opening of the housing 32 is closed by a substantially disk-shaped end frame 35. The magnets 33 (see FIG. 4) fixed to the inner circumferential surface of the housing 32 include N-pole magnets and S-pole magnets that are alternately arranged in the circumferential direction. In the motor 31 of the present embodiment, the magnets 33 each include “four” magnetic poles.

As illustrated in FIGS. 1 and 4, the motor 31 includes an armature 41 arranged at the inner side of the magnets 33. The armature 41 includes a rotation shaft 42 rotatable relative to the stator 34, an armature core 43 fixed to the rotation shaft 42, coils 94 wound around the armature core 43, and a commutator 45 fixed to the rotation shaft 42.

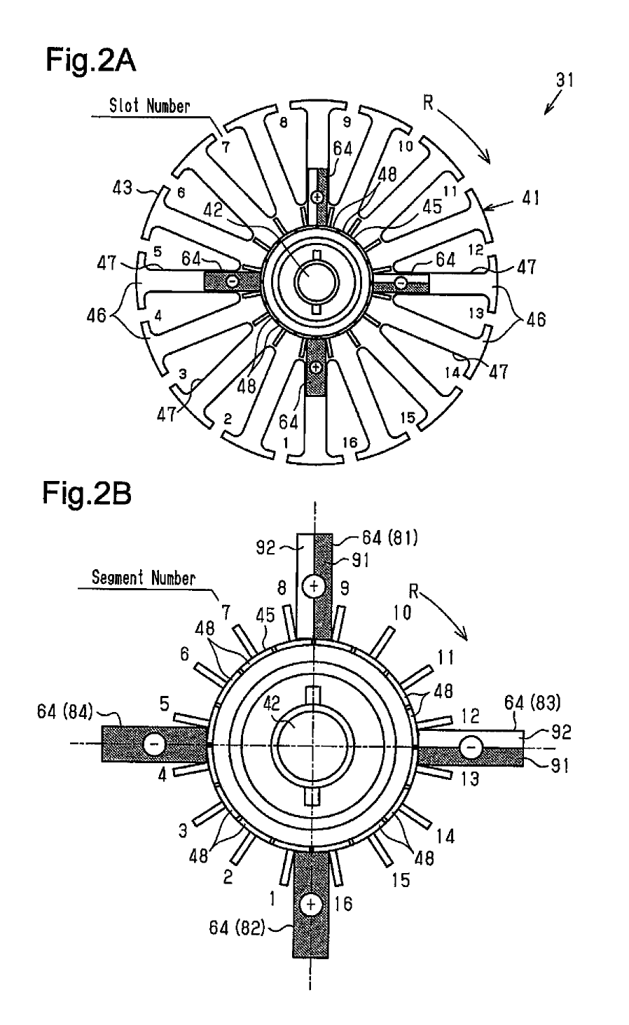

As illustrated in FIGS. 1, 2A and 4, the armature core 43 faces the magnets 33 in the radial direction inside the housing 32. Further, the armature core 43 includes sixteen teeth 46 arranged next to one another in the circumferential direction and radially extending from the central portion of the armature core 43. Adjacent teeth 46 in the circumferential direction are spaced apart to define a slot 47 that accommodates the coils 44 wound around the teeth 46. The armature core 43 that includes sixteen teeth 46 has sixteen slots 47. As illustrated in FIG. 2A, the slot numbers of “1” to “16” are assigned to the slots 47 sequentially in the clockwise direction.

As illustrated in FIG. 1, the commutator 45 is fixed to the rotation shaft 42 at a position closer to the opening of the housing 32 than the armature core 43. The commutator 45 is rotatable integrally with the rotation shaft 42 and accommodated in the housing 32 together with the armature core 43. As illustrated in FIG. 2B, the commutator 45 includes sixteen segments 48 arranged on the outer circumferential surface of the commutator 45. The sixteen segments 48 all have a uniform width in a rotation direction R of the commutator 45 (hereinafter referred to as the rotation direction R) and are arranged at equal angular intervals in the rotation direction R. The adjacent segments 48 in the rotation direction R are separated from each other in the rotation direction R. The segments 48 are assigned segment numbers “1” to “16” sequentially in the clockwise direction as illustrated in FIG. 2B. Hereinafter, “the segment numbers” and “the slot numbers” are each simply referred to using “number”

As illustrated in FIG. 4, each coil 44 is formed by a conductive wire 49 wound around the teeth 46. The conductive wire 49 is wound around three teeth 46 successively arranged in the circumferential direction as a distributed winding. More specifically, the conductive wire 49 is extended from the number “2” segment 48 to the number “11” slot 47, wound a number of times around the three teeth 46 between the number “11” slot 47 and the number “8” slot 47, and then connected to the number “1” segment 48. The conductive wire 49 is subsequently extended from the number “1” segment 48 to the number “10” slot 47, wound a number of times around the three teeth 46 between the number “10” slot 47 and the number “7” slot 47, and then connected to the number “16” segment 48. The conductive wire 49 is subsequently extended from the number “16” segment 48 to the number “9” slot 47, wound a number of times around the three teeth 46 between the number “9” slot 47 and the number “6” slot 47, and connected to the number “15” segment 48. In the same manner, each conductive wire 49 is wound around all of the segments 48 and all of the slots 47 to form the sixteen coils 44. Accordingly, the motor 31 of the present embodiment includes the “sixteen” coils 44.

The commutator 45 further includes short-circuiting members 51 that short-circuit predetermined segments 48 at which the potential is the same. More specifically, the number “1” segment 48 and the number “9” segment 48 are short-circuited by a short-circuiting member 51. The number “2” segment 48 and the number “10” segment 48 are short-circuited by a further short-circuiting member 51. The number “3” segment 48 and the number “11” segment 48 are short-circuited by another short-circuiting member 51. The other segments 48 are short-circuited by the short-circuiting members 51 in the same manner. Accordingly, each short-circuiting member 51 short-circuits segments 48 that are spaced apart by an interval of 180 degrees.

As illustrated in FIG. 1, the motor 31 includes a brush holder 61 arranged in the opening of the housing 32. The brush holder 61 includes a base member 62, which is substantially disk-shaped and has substantially the same size as the end frame 35, and four brush holding portions 63, which are fixed to the end frame 35. The base member 62 is arranged in the opening of the housing 32 adjacent to the end frame 35 in the axial direction.

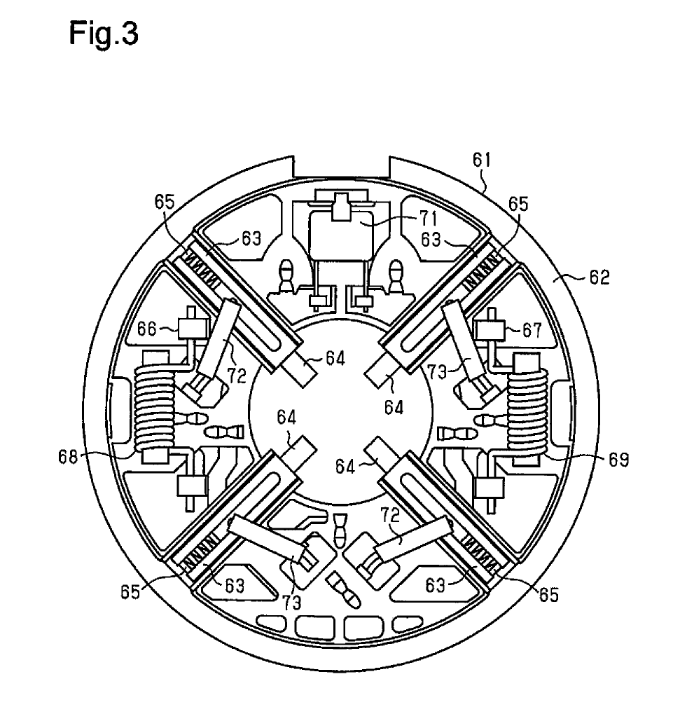

The four brush holding portions 63 are arranged on and fixed to the base member 62 at a side surface facing the inner side (bottom side) of the housing 32. Each of the brush holding portions 63 is formed by a brass plate, for example. As illustrated in FIG. 3, the four brush holding portions 63 are located at four positions on the base member 62 spaced apart from each other in the circumferential direction (same as rotation direction R). In the present embodiment, the four brush holding portions 63 are arranged at equal angular intervals (i.e., intervals of 90 degrees) in the circumferential direction. Each of the brush holding portions 63 extends in the radial direction and has a substantially U-shaped cross-section that is orthogonal to the radial direction and opens toward the base member 62.

A power supply brush 64 is inserted into each of the brush holding portions 63. Each brush holding portion 63 has an internal space that is slightly larger than the power supply brush 64 inserted into the brush holding portion 63 to allow for dimensional errors and expansion caused by changes in the temperature of the power supply brush 64. In other words, the inner surface of each brush holding portion 63 is slightly larger than the outer surface of the inserted power supply brush 64. Accordingly, a small gap is formed between the inner surface of the brush holding portion 63 and the outer surface of the power supply brush 64. Each of the power supply brushes 64 has a substantially rectangular parallelepiped shape (quadrangular prism) that is elongated in the radial direction. As illustrated in FIGS. 1 and 3, the distal end of each power supply brush 64 at the radially inner side protrudes inward in the radial direction from the corresponding brush holding portion 63 and contacts the outer circumferential surface of the commutator 45 (i.e., segments 48) to slide in contact with the surface. The rear end of each power supply brush 64 at the radially outer side is urged toward the radially inner side (toward commutator 45) by a compression coil spring 65 corresponding to an urging member accommodated in the corresponding brush holding portion 63. The movement of each power supply brush 64 in the rotation direction R is restricted by the brush holding portion 63 into which the power supply brush 64 is inserted, and the movement of the power supply brushes 64 in the direction from the rear end toward the distal end is guided by the corresponding brush holding portion 63.

Two power supply terminals 66 and 67 are arranged on the base member 62 on the surface opposite to the side of the brush holding portions 63. Two noise prevention choke coils 68 and 69 and a capacitor 71 are further arranged on the base member 62 on the surface to which the four brush holding portions 63 are fixed. Pig tails 72 extending from two of the four power supply brushes 64 that have the same polarity are electrically connected to the power supply terminal 66 corresponding to one of the two power supply terminals via one of the choke coils 68. Pig tails 73 extending from the two remaining power supply brushes 64 of the same polarity are electrically connected to the power supply terminal 67 corresponding to the other power supply terminal via the other choke coil 69. The capacitor 71 is electrically connected to the two power supply terminals 66 and 67. The power supply terminals 66 and 67 are connected to an external power supply device (not shown). Current supplied from the power supply terminals 66 and 67 to the power supply brushes 64 via the choke coils 68 and 69 and the pig tails 72 and 73 is further supplied to the coils 44 via the commutator 45. This rotates the armature 41. In the motor 31 of the present embodiment, the armature 41 rotates in only one direction. The power supply brushes 64 sequentially slides in contact with the plurality of segments 48 of the commutator 45 as the armature 41 (commutator 45) rotates.

The power supply brushes 64 in the present embodiment will now be described in detail.

As illustrated in FIGS. 3 and 5, the four power supply brushes 64 held by the brush holding portions 63 are arranged at intervals of an angle θ in the rotation direction R. In the present embodiment, the four power supply brushes 64 are arranged at intervals of 90 degrees in the rotation direction R. The four power supply brushes 64 of the present embodiment all have the same external shape. The width D1 of each power supply brush 64 in the rotation direction R is equal to the width D2 of each segment 48 in the rotation direction R.

As illustrated in FIG. 5, two of the four power supply brushes 64 serve as a first anode power supply brush 81 and a second anode power supply brush 82 of an anode. The two remaining power supply brushes 64 serve as a first cathode power supply brush 83 and a second cathode power supply brush 84 of a cathode. The four power supply brushes 64 are arranged in the order of the first anode power supply brush 81, the first cathode power supply brush 83, the second anode power supply brush 82, and the second cathode power supply brush 84 in the rotation direction R.

The first anode power supply brush 81 and the first cathode power supply brush 83 are configured to have an electric resistance that varies in the rotation direction R. More specifically, the first anode power supply brush 81 includes a high-resistance portion 91, which is arranged in an area including a front end (right end in FIG. 5) of the first anode power supply brush 81 in the rotation direction R, and a low-resistance portion 92, which is arranged in an area of the first anode power supply brush 81 excluding the high-resistance portion 91 and has a smaller electric resistance than the high-resistance portion 91. In the same manner, the first cathode power supply brush 83 includes the high-resistance portion 91, which is arranged in an area including a front end of the first cathode power supply brush 83 in the rotation direction R, and the low-resistance portion 92, which is arranged in an area of the first cathode power supply brush 83 excluding the high-resistance portion 91 and has a smaller electric resistance than the high-resistance portion 91. The high-resistance portion 91 and the low-resistance portion 92 included in each of the first anode power supply brush 81 and the first cathode power supply brush 83 are arranged next to one another in the rotation direction R. Each of the first anode power supply brush 81 and the first cathode power supply brush 83 has a multilayer structure including the high-resistance portion 91 and the low-resistance portion 92 (two brush layers) having different electric resistances and overlapped with each other in the rotation direction R (i.e., laminate brush). The widths of the high-resistance portion 91 and the low-resistance portion 92 of each of the first anode power supply brush 81 and the first cathode power supply brush 83 are equal in the rotation direction R. Accordingly, one half of the volume of the first anode power supply brush 81 and the first cathode power supply brush 83 is occupied by the high-resistance portion 91. In each of the first anode power supply brush 81 and the first cathode power supply brush 83, the front half of the distal end surface in the rotation direction R is occupied by the high-resistance portion 91, and the rear half of the distal end surface in the rotation direction R is occupied by the low-resistance portion 92. The first anode power supply brush 81 and the first cathode power supply brush 83 each have a cross section orthogonal to the radial direction that is uniform in the radial direction. In the cross section, the high-resistance portion 91 and the low-resistance portion 92 have a quadrangular shape of the same size. The high-resistance portion 91 is formed by sintering a material of which the main component is carbon (C), and the low-resistance portion 92 is formed by sintering a material of which the main components are copper (Cu) and carbon (C).

Each of the second anode power supply brush 82 and the second cathode power supply brush 84 has a constant electric resistance (i.e., electric resistance that does not vary) in the rotation direction R. The electric resistance of the second anode power supply brush 82 and the second cathode power supply brush 84 is larger than that of the low-resistance portions 92 and equal to that of the high-resistance portions 91 in the present embodiment. In the same manner as the high-resistance portions 91, each of the second anode power supply brush 82 and the second cathode power supply brush 84 is formed by sintering a material of which the main component is carbon (C).

The two anode power supply brushes 64 of the anode are arranged so that the middle of the second anode power supply brush 82 in the rotation direction R is located at the middle of the sliding segment 48 in the rotation direction R when the middle of the first anode power supply brush 81 in the rotation direction R is located at the middle of the sliding segment 48 in the rotation direction R. In the same manner, the two cathode power supply brushes 64 of the cathode are arranged so that the middle of the second cathode power supply brush 84 in the rotation direction R is located at the middle of the sliding segment 48 in the rotation direction R when the middle of the first cathode power supply brush 83 in the rotation direction R is located at the middle of the sliding segment 48 in the rotation direction R. For example, when the middle of the first anode power supply brush 81 in the rotation direction R is located at the middle of the number “2” segment 48 in the rotation direction R, the middle of the second anode power supply brush 82 in the rotation direction is located at the middle of the number “10” segment 48 in the rotation direction R as illustrated in FIG. 5. When the middle of the first cathode power supply brush 83 in the rotation direction R is located at the middle of the number “6” segment 48 in the rotation direction R, the middle of the second cathode power supply brush 84 in the rotation direction R is located at the middle of the number “14” segment 48 in the rotation direction R. The power supply brushes 64 are all arranged to simultaneously come into contact with the segments 48 adjacent to the segments 48 that the power supply brushes 64 are presently contacting. Accordingly, the power supply brushes 64 are all arranged to simultaneously come into contact with the subsequent segments 48.

The advantages of the present embodiment will now be described.

(1) Generally, a power supply brush produces a spark when starting to contact a segment and when separated from the segment. A large spark is particularly produced when the power supply brush separates from the segment. This spark considerably increases wear of the power supply brush. According to the motor 31, all sparks produced when the power supply brushes 64 separate from the segments 48 of the rotating commutator 45 are produced at the front ends of the power supply brushes 64 in the rotation direction R. The high-resistance portions 91 arranged in the areas including the front ends of the first anode power supply brush 81 and the first cathode power supply brush 83 in the rotation direction R, the second anode power supply brush 82, and the second cathode power supply brush 84 each have a larger electric resistance than the electric resistance of the low-resistance portions 92 of the first anode power supply brush 81 and the first cathode power supply brush 83. Accordingly, the electric resistance of the front end of each of the power supply brushes 81 to 84 in the rotation direction R is larger than the electric resistance of each low-resistance portion 92. This configuration limits the generation of a large spark when each power supply brush 64 is separated from the segment 48.

When a portion of the second anode power supply brush 82 that slides in contact with the segment 48 cracks or the second anode power supply brush 82 becomes loose, the first anode power supply brush 81 may be separated from the segment 48 at a later timing than the second anode power supply brush 82. In such a case, the high-resistance portion 91 having a large electric resistance and arranged at the front end of the first anode power supply brush 81 in the rotation direction R limits the generation of a large spark in comparison with a structure in which the electric resistance of the entire first anode power supply brush 81 is equal to the electric resistance of the low-resistance portion 92. Accordingly, wear caused by sparks is reduced. In the same manner, when a portion of the second cathode power supply brush 84 cracks or the second cathode power supply brush 84 becomes loose, the first cathode power supply brush 83 may be separated from the segment 48 at a later timing than the second cathode power supply brush 84. In such a case, the high-resistance portion 91 having a large electric resistance and arranged at the front end of the first cathode power supply brush 83 in the rotation direction R limits the generation of a large spark in comparison with a structure in which the electric resistance of the entire first cathode power supply brush 83 is equal to the electric resistance of the low-resistance portion 92. Accordingly, wear caused by sparks is reduced.

Accordingly, the shortening of the life is limited in the first anode power supply brush 81 and the first cathode power supply brush 83 that include the low-resistance portion 92 having a smaller electric resistance than the second anode power supply brush 82 and the second cathode power supply brush 84.

Moreover, each of the low-resistance portions 92 of the first anode power supply brush 81 and the first cathode power supply brush 83 has a smaller electric resistance than the second anode power supply brush 82 and the second cathode power supply brush 84. This limits increases in electrical loss of the first anode power supply brush 81 and the first cathode power supply brush 83. Accordingly, decreases in output of the motor 31 are limited as compared with a structure in which the power supply brushes 64 are all formed by high-resistance power supply brushes.

In addition, all of the power supply brushes 64 are not power supply brushes having an electric resistance that varies in the rotation direction R, such as the first anode power supply brush 81 and the first cathode power supply brush 83. This facilitates manufacturing of the power supply brushes 64 without increasing manufacturing costs of the power supply brushes 64 as compared with a structure in which the power supply brushes all have an electric resistance that varies in the rotation direction of the commutator.

(2) Each of the first anode power supply brush 81 and the first cathode power supply brush 83 has a multilayer structure in which the high-resistance portion 91 and the low-resistance portion 92 (plural brush layers) having different electric resistances are overlapped with each other in the rotation direction R. Accordingly, each of the first anode power supply brush 81 and the first cathode power supply brush 83 easily changes the electric resistance in the rotation direction R. In addition, the front end of the first anode power supply brush 81 and the first cathode power supply brush 83 in the rotation direction R easily forms the high-resistance portion 91 having a larger electric resistance than the electric resistance of the low-resistance portion 92.

(3) The widths of the first anode power supply brush 81 and the second anode power supply brush 82 of the anode are equal in the rotation direction R. In the same manner, the widths of the first cathode power supply brush 83 and the second cathode power supply brush 84 of the cathode are equal in the rotation direction R. In the present embodiment, the widths of all of the power supply brushes 64 are equal in the rotation direction R. In this case, only one type of mold is needed to manufacture the plurality of power supply brushes 64 for both of the anode and cathode sides. This reduces costs for equipment used to manufacture the power supply brushes 64.

(4) The first anode power supply brush 81 and the second anode power supply brush 82 of the anode simultaneously come into contact with the segments 48 that are adjacent to the segments 48 that are presently in contact with the first anode power supply brush 81 and the second anode power supply brush 82. In the same manner, the first cathode power supply brush 83 and the second cathode power supply brush 84 of the cathode simultaneously come into contact with the segments 48 that are adjacent to the segments 48 that are presently in contact with the first cathode power supply brush 83 and the second cathode power supply brush 84. More specifically, when switching the contacting segments 48, the power supply brushes 64 of the anode and the cathode simultaneously come into sliding contact with the subsequent segments 48. Generally, a motor in which at least one of the anode and the cathode includes a plurality of power supply brushes is configured so that when the power supply brushes switch from the segments that are presently in contact with the power supply brushes to the subsequent segments, the power supply brushes simultaneously come into contact with the adjacent segments. Accordingly, the first anode power supply brush 81, the second anode power supply brush 82, the first cathode power supply brush 83, and the second cathode power supply brush 84 in the present embodiment can be applied to prolong life elongation without the necessity of changing brush holders or the like for holding the power supply brushes. When the power supply brushes 81 to 84 are applied to a conventional motor, the generation of large sparks is reduced from the power supply brushes of the conventional motor.

(5) The high-resistance portion 91 occupies one half of the volume of the first anode power supply brush 81. In the same manner, the high-resistance portion 91 occupies one half of the volume of the first cathode power supply brush 83. In this case, wear caused by sparks from the first anode power supply brush 81 and the first cathode power supply brush 83 is reduced while limiting increases in electrical loss of the first anode power supply brush 81 and the first cathode power supply brush 83. Accordingly, shortening of the life to the first anode power supply brush 81 and the first cathode power supply brush 83 is limited without decreasing the output of the motor 31.

(6) The widths of the first anode power supply brush 81 and the second anode power supply brush 82 of the anode are equal in the rotation direction R. In addition, the first anode power supply brush 81 and the second anode power supply brush 82 simultaneously come into contact with the segments 48 that are adjacent to the segments 48 that are presently in contact with the first anode power supply brush 81 and the second anode power supply brush 82. Accordingly, the first anode power supply brush 81 and the second anode power supply brush 82 are simultaneously separated from the segments 48. In the same manner, the widths of the first cathode power supply brush 83 and the second cathode power supply brush 84 of the cathode are equal in the rotation direction R. In addition, the first cathode power supply brush 83 and the second cathode power supply brush 84 simultaneously contact the segments 48 that are adjacent to the segments 48 that are presently in contact with the first cathode power supply brush 83 and the second cathode power supply brush 84. Accordingly, the first cathode power supply brush 83 and the second cathode power supply brush 84 are simultaneously separated from the segments 48. The first anode power supply brush 81 and the first cathode power supply brush 83, which are provided with the low-resistance portion 92 having a smaller electric resistance than the second anode power supply brush 82 and the second cathode power supply brush 84, each include the high-resistance portion 91 having a larger electric resistance than the electric resistance of the low-resistance portion 92 and arranged at the front end of the first anode power supply brush 81 or the first cathode power supply brush 83 in the rotation direction R at the side separating from the segment 48. This reduces the generation of large sparks when the first anode power supply brush 81 and the first cathode power supply brush 83 are separated from the segments 98. Accordingly, shortening of the first anode power supply brush 81 and the first cathode power supply brush 83 caused by spark wear is limited even in a structure configured so that the first anode power supply brush 81 and the first cathode power supply brush 83 each including the low-resistance portion 92, and the second anode power supply brush 82 and the second cathode power supply brush 84 having a larger electric resistance than the electric resistance of the low-resistance portion 92 are simultaneously separated from the segments 48.

### Second Embodiment

A motor according to a second embodiment will now be described. Same reference numerals are given to those components that are the same as the corresponding components of the first embodiment. Such components will not be described in detail.

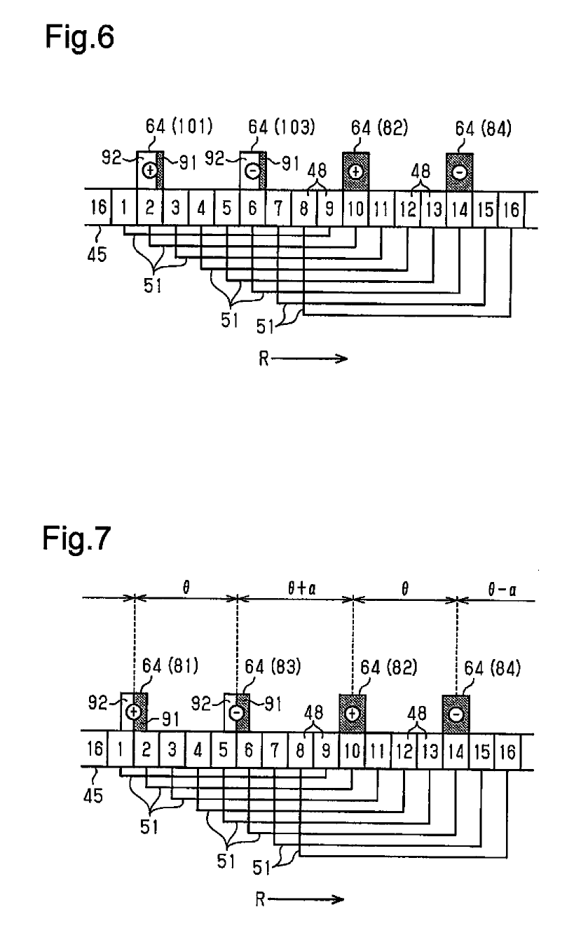

As illustrated in FIG. 6, the motor of the present embodiment includes a first anode power supply brush 101 instead of the first anode power supply brush 81 of the first embodiment, and a first cathode power supply brush 103 instead of the first cathode power supply brush 83 of the first embodiment. External shapes and positions of the first anode power supply brush 101 and the first cathode power supply brush 103 are similar to the external shapes and positions of the first anode power supply brush 81 and the first cathode power supply brush 83 of the first embodiment.

Each of the first anode power supply brush 101 and the first cathode power supply brush 103 includes the high-resistance portion 91, which is arranged in an area including a front end (right end in FIG. 6) of the power supply brush 101 or 103 in the rotation direction R, and the low-resistance portion 92, which is arranged at the rear side of the high-resistance portion 91 of the power supply brush 101 or 103 in the rotation direction R. Each of the first anode power supply brush 101 and the first cathode power supply brush 103 is configured to have an electric resistance that varies in the rotation direction R. The high-resistance portion 91 and the low-resistance portion 92 of each of the first anode power supply brush 101 and the first cathode power supply brush 103 are arranged next to one another in the rotation direction R. Each of the first anode power supply brush 101 and the first cathode power supply brush 103 has a multilayer structure which includes the high-resistance portion 91 and the low-resistance portion 92 (two brush layers) having different electric resistances and overlapped with each other in the rotation direction R (i.e., forms laminate brush).

The width of the high-resistance portion 91 of each of the first anode power supply brush 101 and the first cathode power supply brush 103 in the rotation direction R is smaller than the width of the low-resistance portion 92 in the rotation direction R. In the present embodiment, the width of each of the high-resistance portions 91 of the first anode power supply brush 101 and the first cathode power supply brush 103 in the rotation direction R is approximately one fourth of the width of each of the power supply brushes 101 and 103 in the rotation direction R, and the width of each low-resistance portions 92 of the first anode power supply brush 101 and the first cathode power supply brush 103 in the rotation direction R is approximately three fourths of the width of each of the power supply brushes 101 and 103 in the rotation direction R. Approximately one fourth of the volume of each of the first anode power supply brush 101 and the first cathode power supply brush 103 is occupied by the high-resistance portion 91. For each of the first anode power supply brush 101 and the first cathode power supply brush 103, approximately one fourth of the front side of the distal end surface in the rotation direction R is occupied by the high-resistance portion 91, and the remaining area is occupied by the low-resistance portion 92. The first anode power supply brush 101 and the first cathode power supply brush 103 each have a cross section orthogonal to the radial direction that is uniform in the radial direction. In the cross section, each of the high-resistance portions 91 has a quadrangular shape having a width that is approximately one fourth of the width of each of the power supply brushes 101 and 103 in the rotation direction R, and each of the low-resistance portions 92 has a quadrangular shape having a width that is approximately three fourths of the width of the power supply brushes 101 and 103 in the rotation direction R.

In addition to advantages (1) to (4) and (6) of the first embodiment, the present embodiment has the advantages similar described below

(7) Approximately one fourth of the volume of the first anode power supply brush 101 is occupied by the high-resistance portion 91. In the same manner, approximately one fourth of the volume of the first cathode power supply brush 103 is occupied by the high-resistance portion 91. In this case, wear caused by sparks from the first anode power supply brush 101 and the first cathode power supply brush 103 decreases without increasing electrical losses of the first anode power supply brush 101 and the first cathode power supply brush 103. Accordingly, shortening of life of the first anode power supply brush 101 and the first cathode power supply brush 103 is limited without decreasing the output of the motor.

### Third Embodiment

A motor according to a third embodiment will now be described. Same reference numerals are given to those components that are the same as the corresponding components of the first embodiment. Such components will not be described in detail.

As illustrated in FIG. 7, the first cathode power supply brush 83 is arranged at a position shifted from the first anode power supply brush 81 by an angle θ in the rotation direction R. The second anode power supply brush 82 is arranged at a position shifted from the first cathode power supply brush 83 by an angle (θ+α) in the rotation direction R, that is, at a position shifted from the first anode power supply brush 81 by an angle (2θ+α) in the rotation direction R. The second cathode power supply brush 84 is arranged at a position shifted from the second anode power supply brush 82 by the angle θ in the rotation direction R, that is, at a position shifted from the first cathode power supply brush 83 by the angle (2θ+α) in the rotation direction R. The second cathode power supply brush 84 and the first anode power supply brush 81 are shifted from each other by an angle (θ−α) in the rotation direction R. In the present embodiment, the angle θ is set to 90 degrees. The angle α is an angle set beforehand and corresponds to one half of the width of each power supply brush 64 in the rotation direction R.

When the second anode power supply brush 82 contacts only the number “10” segment 48 as illustrated in FIG. 7, for example, the first anode power supply brush 81 contacts both of the number “2” segment 48, which is short-circuited with the number “10” segment 48, and the number “1” segment 48, which is located at the rear side of the number “2” segment 48 in the rotation direction R. In this case, the low-resistance portion 92 at the rear side of the first anode power supply brush 81 in the rotation direction R contacts the number “1” segment 48, and the high-resistance portion 91 at the front side of the first anode power supply brush 81 in the rotation direction R contacts the number “2” segment 48. When the second cathode power supply brush 84 contacts only the number “14” segment 48 in this state, the first cathode power supply brush 83 contacts both of the number “6” segment 48, which is short-circuited with the number “14” segment 48, and the number “5” segment 48, which is located at the rear side of the number “6” segment 48 in the rotation direction R. In this case, the low-resistance portion 92 at the rear side of the first cathode power supply brush 83 in the rotation direction R contacts the number “5” segment 48, and the high-resistance portion 91 at the front side of the first cathode power supply brush 83 in the rotation direction R contacts the number “6” segment 48.

In this manner, when the positions of the second anode power supply brush 82 and the second cathode power supply brush 84 are shifted from each other by the angle α in the rotation direction R, the commutation ending time (time separated from segments 48) of the second anode power supply brush 82 and the second cathode power supply brush 84 is delayed from that of the first anode power supply brush 81 and the first cathode power supply brush 83 by a predetermined time. In this case, as described above, the first anode power supply brush 81 and the second anode power supply brush 82, which have the same polarity, each contact a segment 48 short-circuited by the short-circuiting member 51. In the same manner, the first cathode power supply brush 83 and the second cathode power supply brush 84, which have the same polarity, each contact a segment 48 short-circuited by the short-circuiting member 51. Accordingly, the power supply brushes 81 to 84 commutate the same coil 44. The commutation ending time of the second anode power supply brush 82 and the second cathode power supply brush 84 is delayed from that of the first anode power supply brush 81 and the first cathode power supply brush 83 by the predetermined period. Thus, sparks are produced only from the high-resistance second anode power supply brush 82 and second cathode power supply brush 84 when separated from the segments 48.

In addition to advantages (1) to (3) and (5) of the first embodiment, the present embodiment has the advantages described below.

(8) The second anode power supply brush 82 is arranged to be separated from a segment 48 later than the first anode power supply brush 81, which has the same polarity as the second anode power supply brush 82. In the same manner, the second cathode power supply brush 84 is arranged to be separated from a segment 48 later than the first cathode power supply brush 83, which has the same polarity as the second cathode power supply brush 84. In this case, sparks are produced only from the second anode power supply brush 82 and the second cathode power supply brush 84 that are separated from the segments 48 at a delayed timing. This reduces sparks produced between the segments 48 and the first anode power supply brush 81 and the first cathode power supply brush 83, which include the low-resistance portion 92. Thus, the shortening of the life of the first anode power supply brush 81 and the first cathode power supply brush 83 is limited. Furthermore, the electric resistance of each the second anode power supply brush 82 and the second cathode power supply brush 84 is larger than the electric resistance of each of the low-resistance portions 92 of the first anode power supply brush 81 and the first cathode power supply brush 83. This reduces sparks produced when the second anode power supply brush 82 and the second cathode power supply brush 84 are separated from the segments 48. Accordingly, the shortening of life of the second anode power supply brush 82 and the second cathode power supply brush 84 caused by spark wear is limited even in a structure that produces sparks only from the second anode power supply brush 82 and the second cathode power supply brush 84 when separated from the segments 48.

### Fourth Embodiment

A motor according to a fourth embodiment will now be described. Same reference numerals are given to those components that are the same as the corresponding components of the first embodiment. Such components will not be described in detail.

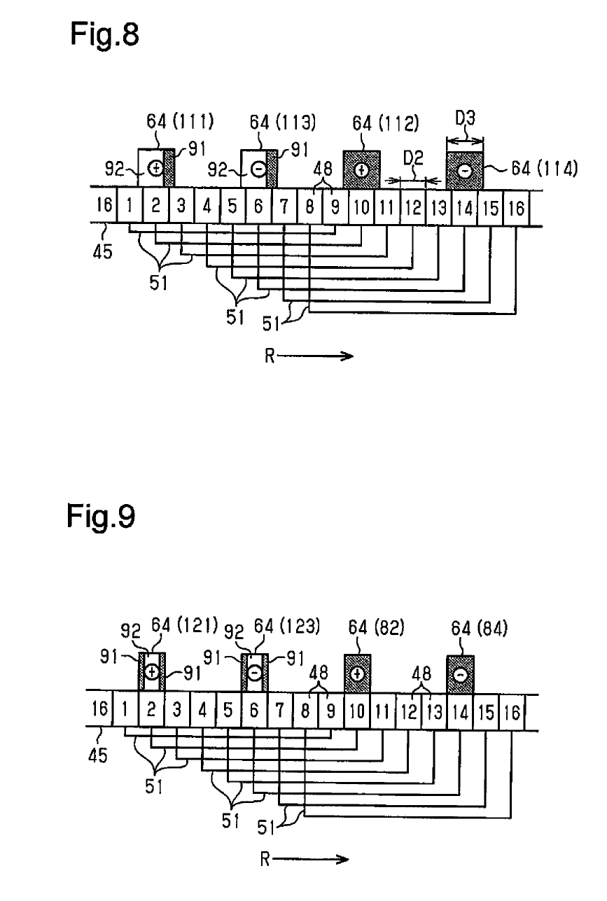

As illustrated in FIG. 8, a first anode power supply brush 111, a second anode power supply brush 112, a first cathode power supply brush 113, and a second cathode power supply brush 114 included in the motor of the present embodiment all have an identical external shape and are arranged at equal angular intervals (90 degrees in the present embodiment) in the rotation direction R. The first anode power supply brush 111, the first cathode power supply brush 113, the second anode power supply brush 112, and the second cathode power supply brush 114 are arranged in this order in the rotation direction R.

The width D3 of each of the power supply brushes 111 to 114 in the rotation direction R (only width D3 of second cathode power supply brush 114 is shown as representative example) is larger than the width D2 of each of the segments 48 (width of any single segment 48) in the rotation direction R and smaller than a width that is two times larger than the width D2 of the segments 48 in the rotation direction R. In the present embodiment, the width D3 of the power supply brushes 111 to 114 in the rotation direction R is a width that is approximately 1.5 times larger than the width D2 of each segment 48 in the rotation direction R.

Each of the first anode power supply brush 111 and the first cathode power supply brush 113 includes the high-resistance portion 91, which is arranged in a portion including a front end (right end in FIG. 8) of the power supply brush 111 or 113 in the rotation direction R, and the low-resistance portion 92, which is arranged at the rear side the high-resistance portion 91 of the corresponding power supply brush 111 or 113 in the rotation direction R. The electric resistance of each of the first anode power supply brush 111 and the first cathode power supply brush 113 is varied in the rotation direction R. The high-resistance portion 91 and the low-resistance portion 92 included in each of the first anode power supply brush 111 and the first cathode power supply brush 113 are arranged next to one another in the rotation direction R. Each of the first anode power supply brush 111 and the first cathode power supply brush 113 has a multilayer structure that includes the high-resistance portion 91 and the low-resistance portion 92 (two brush layers) having different electric resistances and overlapped with each other in the rotation direction R (i.e., laminate brush).

The width of the high-resistance portion 91 of each of the first anode power supply brush 111 and the first cathode power supply brush 113 in the rotation direction R is smaller than the width of the low-resistance portion 92 in the rotation direction. In the present embodiment, the width of the high-resistance portions 91 of the first anode power supply brush 111 and the first cathode power supply brush 113 in the rotation direction R is approximately one third of the width of each of the power supply brushes 111 and 113 in the rotation direction R, and the width of each of the low-resistance portions 92 of the first anode power supply brush 111 and the first cathode power supply brush 113 in the rotation direction R is approximately two thirds of the width of each of the power supply brushes 111 and 113 in the rotation direction R. Approximately one third of the volume of each of the first anode power supply brush 111 and the first cathode power supply brush 113 is occupied by the high-resistance portion 91. For each of the first anode power supply brush 111 and the first cathode power supply brush 113, approximately one third of the front side of the distal end surface in the rotation direction R is occupied by the high-resistance portion 91, and the remaining area is occupied by the low-resistance portion 92. The first anode power supply brush 111 and the first cathode power supply brush 113 each have a cross section orthogonal to the radial direction that is uniform in the radial direction. In the cross section, each of the high-resistance portions 91 has a quadrangular shape having a width approximately one third of the width of each the power supply brushes 111 and 113 in the rotation direction R, and the low-resistance portions 92 has a quadrangular shape having a width that is approximately two thirds of the width of each of the power supply brushes 111 and 113 in the rotation direction R.

Each of the second anode power supply brush 112 and the second cathode power supply brush 114 has an electric resistance that is constant in the rotation direction R (i.e., has unchangeable electric resistance) in the same manner as the second anode power supply brush 82 and the second cathode power supply brush 84 of the first embodiment. The electric resistance of each of the second anode power supply brush 112 and the second cathode power supply brush 114 is larger than the electric resistance of the low-resistance portion 92 and equal to the electric resistance of the high-resistance portion 91 in the present embodiment.

When the middle of the second anode power supply brush 112 in the rotation direction R is located at the middle of the number “10” segment 48 in the rotation direction R in this configuration, for example, the second anode power supply brush 112 contacts the number “10” segment 48 and the numbers “9” and “11” segments 48 located at the two sides of the number “10” segment 48 as illustrated in FIG. 8. In this case, the middle of the first anode power supply brush 111 in the rotation direction R is located at the middle of the number “2” segment 48, which is short-circuited with the number “10” segment 48 in the rotation direction R, and contacts the number “2” segment 48 and the numbers “1” and “3” segments 48 located at the two sides of the number “2” segment 48. In addition, the middle of the second cathode power supply brush 114 in the rotation direction R is located at the middle of the number “14” segment 48 in the rotation direction R and contacts the number “14” segment 48 and the numbers “13” and “15” segments 48 located at opposite sides of the number “14” segment 48. The middle of the first cathode power supply brush 113 in the rotation direction R is located at the middle of the number “6” segment 48, which is short-circuited with the number “14” segment 48 in the rotation direction R, and contacts the number “6” segment 48 and the numbers “5” and “7” segments 48 located at the two sides of the number “6” segment 48.

In addition to advantages (1) to (4) and (6) of the first embodiment, the present embodiment has the advantages described below.

(9) Approximately one third of the volume of the first anode power supply brush 111 is occupied by the high-resistance portion 91. In the same manner, approximately one third of the volume of the first cathode power supply brush 113 is occupied by the high-resistance portion 91. This reduces wear caused by sparks from the first anode power supply brush 111 and the first cathode power supply brush 113 while limiting increases in electrical losses of the first anode power supply brush 111 and the cathode power supply brush 113. Accordingly, the shortening of the first anode power supply brush 111 and the first cathode power supply brush 113 is limited without decreasing the output of the motor.

(10) The width D3 of each of the power supply brushes 111 to 114 in the rotation direction R is larger than the width D2 of each of the segments 48 in the rotation direction R. In other words, the width of the power supply brushes 111 to 114 in the circumferential direction is larger than each width of the segments 48 in the circumferential direction. Thus, the volume of each of the power supply brushes 111 to 114 is larger than the volume of a power supply brush of which the width is equal to the width of each segment in the circumferential direction. Accordingly, the shortening of the life of the power supply brushes 111 to 114 caused by spark wear is further limited.

### Fifth Embodiment

A motor according to a fifth embodiment will now be described. Same reference numerals are given to those components that are the same as the corresponding components of the first embodiment. Such components will not be described in detail.

As illustrated in FIG. 9, the motor of the present embodiment includes a first anode power supply brush 121, instead of the first anode power supply brush 81 of the first embodiment, and a first cathode power supply brush 123, instead of the first cathode power supply brush 83 of the first embodiment. External shapes and positions of the first anode power supply brush 121 and the first cathode power supply brush 123 are the same as the external shapes and positions of the first anode power supply brush 81 and the first cathode power supply brush 83 of the first embodiment. Accordingly, when the middle of the first anode power supply brush 121 in the rotation direction R is located at the middle of the segment 98 in the rotation direction R on which the first anode power supply brush 121 is sliding in contact, the middle of the second anode power supply brush 82, which has the same polarity as the first anode power supply brush 121, in the rotation direction R is located at the middle of the segment 48 in the rotation direction R on which the second anode power supply brush 82 is sliding in contact. In the same manner, when the middle of the first cathode power supply brush 123 in the rotation direction R is located at the middle of the segment 48 in the rotation direction R on which the first cathode power supply brush 123 is sliding in contact, the middle of the second cathode power supply brush 84, which has the same polarity as the first cathode power supply brush 123, in the rotation direction R is located at the middle of the segment 48 in the rotation direction R on which the second cathode power supply brush 89 is sliding in contact.

The first anode power supply brush 121 and the first cathode power supply brush 123 each include the high-resistance portions 91 at the two ends of the power supply brush 121 or 123 in the rotation direction R. A portion between the two high-resistance portions 91 in each of the first anode power supply brush 121 and the first cathode power supply brush 123 corresponds to the low-resistance portion 92. In this manner, each of the first anode power supply brush 121 and the first cathode power supply brush 123 has an electric resistance varied in the rotation direction R by the arrangement of the two high-resistance portions 91 and the one low-resistance portion 92 in the rotation direction R. Each of the first anode power supply brush 121 and the first cathode power supply brush 123 further has a multilayer structure including the high-resistance portion 91 and the low-resistance portion 92 having different electric resistances and overlapped with each other in the rotation direction R (i.e., laminate brush).

The width of each high-resistance portion 91 in the first anode power supply brush 121 and the first cathode power supply brush 123 in the rotation direction R is smaller than the width of the low-resistance portion 92 in the rotation direction R. In the present embodiment, the width of each high-resistance portion 91 in the first anode power supply brush 121 and the first cathode power supply brush 123 in the rotation direction is approximately one fourth of the width of each of the power supply brushes 121 and 123 in the rotation direction R. The width of each low-resistance portion 92 in the rotation direction is approximately two fourths of the width of each of the power supply brushes 121 and 123 in the rotation direction R. Approximately two fourths of the volume of each of the first anode power supply brush 121 and the first cathode power supply brush 123 is occupied by the two high-resistance portions 91. In the distal end surface of each of the first anode power supply brush 121 and the first cathode power supply brush 123, one of the high-resistance portions 91 occupies approximately one fourth of the volume at the front side in the rotation direction R. The other high-resistance portion 91 occupies approximately one fourth of the volume at the rear side in the rotation direction R. The low-resistance portion 92 occupies the remaining area. The first anode power supply brush 121 and the first cathode power supply brush 123 has a cross section orthogonal to the radial direction that is uniform in the radial direction. In the cross section, each of the high-resistance portions 91 has a quadrangular shape having a width that is approximately one fourth of the width of each of the power supply brushes 121 and 123 in the rotation direction R, and each of the low-resistance portions 92 has a quadrangular shape having a width that is approximately two fourths of the width of each of the power supply brushes 121 and 123 in the rotation direction R.

In addition to advantages (1) to (6) of the first embodiment, the present embodiment has the following advantages.

(11) When the middle of the first anode power supply brush 121 in the rotation direction R is located at the middle of the segment 48 in the rotation direction R on which the first anode power supply brush 121 is sliding in contact, the middle of the second anode power supply brush 82, which has the same polarity as the first anode power supply brush 121, in the rotation direction R is located at the middle of the segment 48 in the rotation direction R on which the second anode power supply brush 82 is sliding in contact. In the same manner, when the middle of the first cathode power supply brush 123 in the rotation direction R is located at the middle of the segment 48 in the rotation direction R on which the first cathode power supply brush 123 is sliding in contact, the middle of the second cathode power supply brush 84 in the rotation direction R, which has the same polarity as the first cathode power supply brush 123, in the rotation direction R on which the second cathode power supply brush 84 is sliding in contact. This allows the motor of the present embodiment to function as a bidirectional rotation motor.

Each of the first anode power supply brush 121 and the first cathode power supply brush 123 includes the high-resistance portions 91 at the two ends of the power supply brush 121 or 123 in the rotation direction R. Thus, the high-resistance portion 91 is present at the front end in the rotation direction of the commutator 45 for each of the first anode power supply brush 121 and the first cathode power supply brush 123 regardless of whichever circumferential direction the commutator 45 is rotated in. Accordingly, sparks are produced from the high-resistance portions 91 when the first anode power supply brush 121 and the first cathode power supply brush 123 are separated from the segments 48 during rotation of the commutator 45 regardless of direction. Thus, the bidirectional rotation motor also limits shortening of the life of the first anode power supply brush 121 and the first cathode power supply brush 123 that include the low-resistance portions 92 having a smaller electric resistance than the second anode power supply brush 82 and the second cathode power supply brush 84.

### Sixth Embodiment

A motor according to a sixth embodiment will now be described. Same reference numerals are given to those components that are the same as the corresponding components of the first embodiment. Such components will not be described in detail.

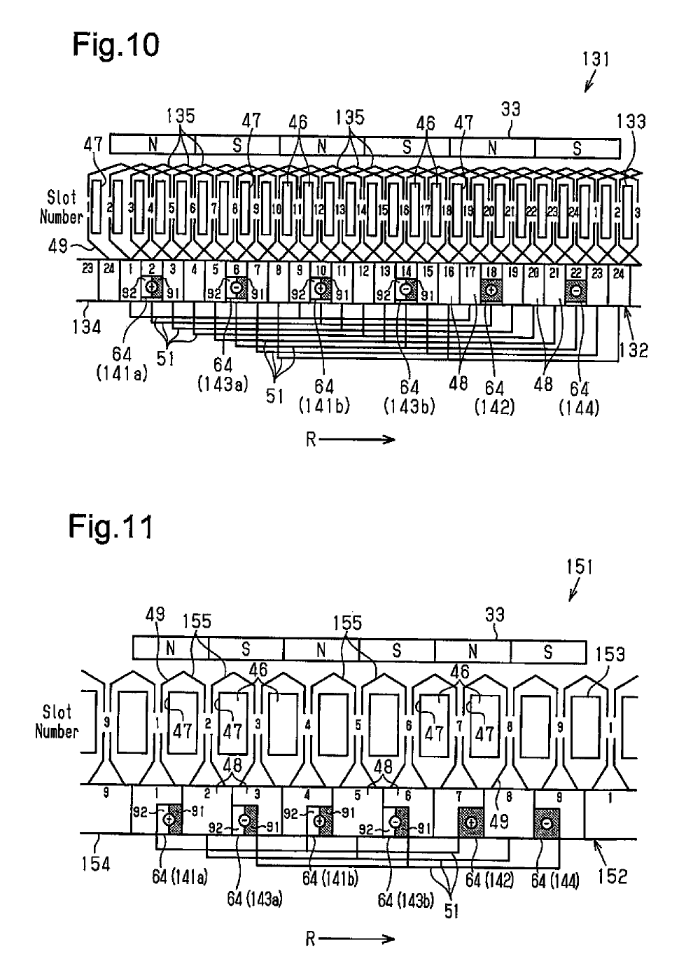

The magnets 33 of a motor 131 have “six” magnetic poles in the present embodiment illustrated in FIG. 10. An armature core 133 of an armature 132 included in the motor 131 has twenty-six teeth 46, which are arranged next to one another in the circumferential direction, and twenty-four slots 47. As illustrated in FIG. 10, the slots 47 are sequentially assigned the slot numbers of “1” to “24” in the rotation direction R.

A commutator 134 of the armature 132 includes twenty-four segments 48 arranged on the outer circumferential surface of the commutator 134 at equal angular intervals in the circumferential direction. As illustrated in FIG. 10, the segments 48 are sequentially assigned the segment number of “1” to “24” in the rotation direction R.

A conductive wire 49 is wound around the armature core 133 to form a plurality of coils 135. The conductive wires 49 are wound as a “distributed winding” around three teeth 46 that are successively arranged in the circumferential direction. More specifically, the conductive wire 49 is extended from the number “24” segment 48 to the number “1” slot 47, wound a number of times around the three teeth 46 between the number “1” slot 47 and the number “4” slot 47, and connected to the number “1” segment 48. The conductive wire 49 is subsequently extended from the number “1” segment 48 to the number “2” slot 47, wound a number of times around the three teeth 46 between the number “2” slot 47 and the number “5” slot 47, and connected to the number “3” segment 48. The conductive wire 49 is subsequently extended from the number “3” segment 48 to the number “4” slot 47, wound a number of times around the three teeth 46 between the number “4” slot 47 and the number “7” slot 47, and connected to the number “4” segment 48. In the same manner, the conductive wire 49 is wound around all of the segments 48 and all the slots 47 to form the twenty-four coils 135. Accordingly, the motor 131 of the present embodiment includes the “twenty-four” coils 135.

The commutator 134 further includes short-circuiting members 51, each short-circuiting predetermined segments 48 at which the potential is the same, that is, the segments 48 arranged at angular intervals of 120 degrees in the present embodiment. More specifically, the three number “1,” number “9,” and number “17” segments 48 are short-circuited by the corresponding short-circuiting member 51. The three number “2,” number “10,” and number “18” segment 48 are short-circuited by the corresponding short-circuiting member 51. The three number “3,” number “11,” and number “19” segments 48 are short-circuited by the corresponding short-circuiting member 51. The remaining segments 48 are short-circuited by the corresponding short-circuiting members 51 in the manner.

The motor 131 includes six power supply brushes 64 that slide in contact with the outer circumferential surface of the commutator 134. In the present embodiment, the six power supply brushes 64 are arranged at angular intervals of 60 degrees in the rotation direction R of the commutator 134. The six power supply brushes 64 in the present embodiment all have a uniform external shape. The width of each power supply brush 64 in the rotation direction R is equal to the width of each segment 48 in the rotation direction R.

Three of the six power supply brushes 64 are anode power supply brushes defined as first anode power supply brushes 141a and 141b and a second anode power supply brush 142. The remaining two power supply brushes 64 are cathode power supply brushes defined as first cathode power supply brushes 143a and 143b and a second cathode power supply brush 144. The six power supply brushes 64 are arranged in the order of the first anode power supply brush 141a, the first cathode power supply brush 143a, the first anode power supply brush 141b, the first cathode power supply brush 143b, the second anode power supply brush 142, and the second cathode power supply brush 144 in the rotation direction R.

The configurations of the first anode power supply brushes 141a and 141b and the first cathode power supply brushes 143a and 143b are the same as the first anode power supply brush 81 and the first cathode power supply brush 83 of the first embodiment. The first anode power supply brushes 141a and 141b and the first cathode power supply brushes 143a and 143b each include the high-resistance portion 91 and the low-resistance portion 92. Moreover, the configurations of the second anode power supply brush 142 and the second cathode power supply brush 144 are the same as the second anode power supply brush 82 and the second cathode power supply brush 84 of the first embodiment.

The three anode power supply brushes 64 are arranged so that the middle of the second anode power supply brush 142 in the rotation direction R is located at the middle of the segment 48 in the rotation direction R on which the second anode power supply brush 142 is sliding in contact when the middle of each of the first anode power supply brushes 141a and 141b in the rotation direction R is located at the middle of the segment 48 in the rotation direction R on which the first anode power supply brush 141a or 141b is sliding in contact. In the same manner, the three cathode power supply brushes 64 are arranged so that the middle of the second cathode power supply brush 144 in the rotation direction R is located at the middle of the segment 48 in the rotation direction R on which the second cathode power supply brush 144 is sliding in contact when the middle of each of the first cathode power supply brushes 143a and 143b in the rotation direction R is located at the middle of the segment 48 in the rotation direction R on which the first cathode power supply brush 143a or 143b is sliding in contact. For example, as illustrated in FIG. 10, when the middle of the first anode power supply brush 141a in the rotation direction R is located at the middle of the number “2” segment 48 in the rotation direction R and the middle of the first anode power supply brush 141b in the rotation direction R is located at the middle of the number “10” segment 48 in the rotation direction R, the middle of the second anode power supply brush 142 in the rotation direction R is located at the middle of the number “18” segment 48 in the rotation direction R. In the same manner, when the middle of the first cathode power supply brush 143a in the rotation direction R is located at the middle of the number “6” segment 48 in the rotation direction R and the middle of the first cathode power supply brush 143b in the rotation direction R is located at the middle of the number “14” segment 48 in the rotation direction R, the middle of the second cathode power supply brush 144 in the rotation direction R is located at the middle of the number “22” segment 48 in the rotation direction R. The power supply brushes 64 are arranged so that they all simultaneously come into contact with the segments 48 that are adjacent to the segments 48 that the power supply brushes 64 are presently in contact with. Accordingly, the power supply brushes 64 are arranged so that they all simultaneously come into contact with the new segments 48.

The present embodiment has advantages (1) to (6) of the first embodiment.

### Seventh Embodiment

A motor according to a seventh embodiment will now be described. Same reference numerals are given to those components that are the same as the corresponding components of the first embodiment and the sixth embodiment. Such components will not be described in detail.

The magnets 33 of a motor 151 in the present embodiment illustrated in FIG. 11 has “six” magnetic poles. An armature core 153 of an armature 152 included in the motor 151 includes nine teeth 46, which are arranged in the circumferential direction, and nine slots 47. As illustrated in FIG. 11, the slots 47 are sequentially assigned the slot number of “1” to “9” in the rotation direction R.

A commutator 154 of the armature 152 includes the nine segments 48 arranged on the outer circumferential surface of the commutator 154 at equal angular intervals in the circumferential direction. As illustrated in FIG. 11, the segments 48 are sequentially assigned the segment numbers of “1” to “9” in the rotation direction R.

A conductive wire 49 is wound around the armature core 153 to form a plurality of coils 155. The conductive wire 49 is wound around the teeth 46 as a concentrated winding. More specifically, the conductive wire 49 is extended from the number “1” segment 48 to the number “1” slot 47, wound a number of times around the teeth 46 between the number “1” slot 47 and the number “2” slot 47 to form a single coil 155, and connected to the number “2” segment 48. The conductive wire 49 is further extended from the number “2” segment 48 to the number “2” slot 47, wound a number of times around the teeth 46 between the number “2” slot 47 and the number “3” slot 47 to form a single coil 155, and connected to the number “3” segment 48. The conductive wire 49 is further extended from the number “3” segment 48 to the number “3” slot 47, wound a number of times around the teeth 46 between the number “3” slot 47 and the number “4” slot 47 to form a single coil 155, and connected to the number “4” segment 48. In the same manner, the conductive wire 49 is wound around all of the segments 48 and all of the slots 47 to form the nine coils 155. Accordingly, the motor 151 of the present embodiment includes the “nine” coils 155.

The commutator 154 further includes the short-circuiting members 51 each of which short-circuits the predetermined segments 48 at the same potential, i.e., the segments 48 arranged at an angular interval of 120 degrees in the present embodiment. More specifically, the three number “1,” number “4,” and number “7” segments 48 are short-circuited by the corresponding short-circuiting member 51. The three number “2,” number “5,” and number “8” segments 98 are short-circuited by the corresponding short-circuiting member 51. The three number “3,” number “6,” and number “9” segments 48 are short-circuited by the corresponding short-circuiting member 51.

The motor 151 includes the six power supply brushes 64 that slide in contact with the outer circumferential surface of the commutator 154. In the same manner as the sixth embodiment, the six power supply brushes 64 of the present embodiment include the first anode power supply brushes 141a and 141b, the second anode power supply brush 142, the first cathode power supply brushes 143a and 143b, and the second cathode power supply brush 144. In the present embodiment, the power supply brushes 141a, 141b, 142, 143a, 143b, and 144 are located at positions that are the same as the sixth embodiment. However, the width of each of the power supply brushes 141a, 141b, 142, 143a, 143b, and 144 in the rotation direction R is one half of the width of each of the segments 48 in the rotation direction R.

When the middle of each of the first anode power supply brushes 141a and 141b of the anode in the rotation R direction is located at the middle of the segment 48 on which the first anode power supply brushes 141a and 141b are sliding in contact, the middle of the second anode power supply brush 142 of the anode in the rotation direction R is located at the middle of the segment 48 in the rotation direction R on which the second anode power supply brush 142 is sliding in contact. When the middle of each of the first cathode power supply brushes 143a and 143b of the cathode in the rotation R direction are located at the middle of the segment 48 in the rotation direction R on which the first cathode power supply brushes 143a and 143b are sliding in contact, the middle of the second cathode power supply brush 144 of the cathode in the rotation direction R is located at the middle of the segment 48 on which the second cathode power supply brush 144 is sliding in contact.

The present embodiment has advantages (1) to (6) of the first embodiment.

The embodiments described above may be modified as described below.

The proportion that the high-resistance portion 91 occupies in the volume of each of the first anode power supply brushes 81, 101, 111, 121, 141a, and 141b and the first cathode power supply brushes 83, 103, 113, 123, 143a, and 143b is not limited to the proportion described in each of the above embodiments and may be changed.

The widths of the first anode power supply brushes 81, 101, 111, 121, 141a, and 141b, the first cathode power supply brushes 83, 103, 113, 123, 143a, and 143b, the second anode power supply brushes 82, 112, and 142, and the second cathode power supply brushes 84, 114, and 144 in the rotation direction R are not limited to the widths described in each of the above embodiments and may be changed.

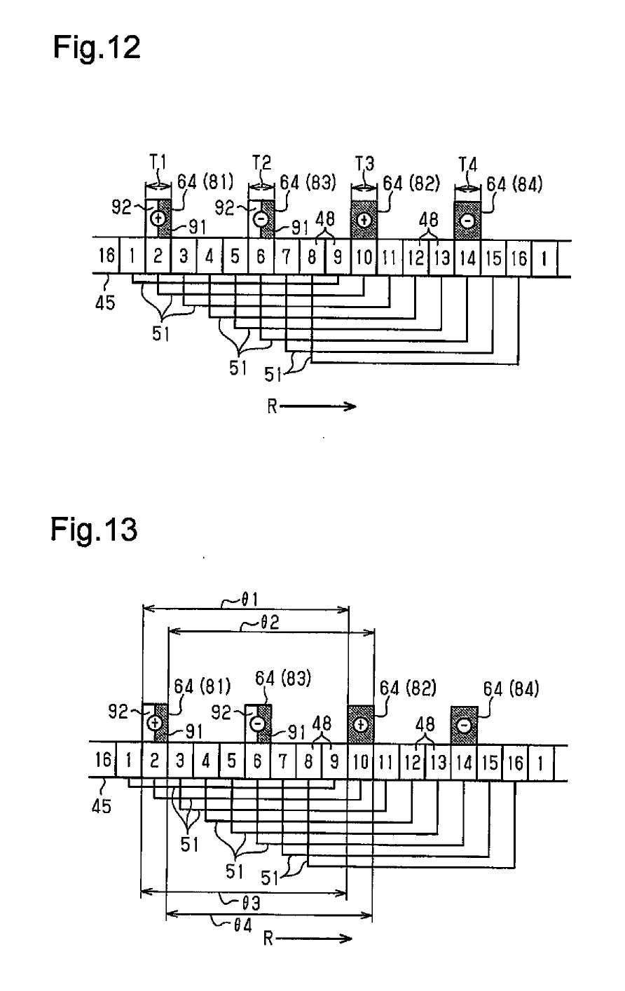

For example, in the first embodiment, the widths of the power supply brushes 64 in the rotation direction R may be the same in at least either one of the anode and the cathode. This example will now be described in detail with reference to FIG. 12. In this case, “T1” represents the width of the first anode power supply brush 81 in the rotation direction R, “T2” represents the width of the first cathode power supply brush 83 in the rotation direction R, “T3” represents the width of the second anode power supply brush 82 in the rotation direction R, and “T4” represents the width of the second cathode power supply brush 84 in the rotation direction R. In this case, any one of following conditions 1 to 4 may be satisfied.

Condition 1: T1=T3

Condition 2: T2=T4

Condition 3: T1=T3, T2=T4

Condition 4: T1=T2=T3=T4

In the first embodiment, for example, the commutation starting time and the commutation ending time may be the same for each coil 44 of the power supply brushes 64 of at least either one of the anode and the cathode. This example will now be described in detail with reference to FIG. 13. As shown in FIG. 13, “61” represents the deviation angle between the rear end of the first anode power supply brush 81, which is an anode power supply brush, in the rotation direction R, and the rear end of the second anode power supply brush 82, which is also an anode power supply brush, in the rotation direction R. Further, “62” represents the deviation angle between the front end of the same first anode power supply brush 81 in the rotation direction R and the front end of the same second anode power supply brush 82 in the rotation direction R. When the first anode power supply brush 81 and the second anode power supply brush 82 switches segments 48 on which they slide, the rear end in the rotation direction R is the end where contact starts with the new segment 48, and the front end in the rotation direction R is the end separated from the segment 48. In addition, “θ3” represents the deviation angle in the rotation direction R between the rear ends of the two segments 48 that the first anode power supply brush 81 and the second anode power supply brush 82, which are anodes, contact (angle between rear ends in rotation direction R), and “θ4” represent the deviation angle formed between the front ends of these two segments 48 that the first anode power supply brush 81 and the second anode power supply brush 82 contact (angle between front ends in rotation direction R). The two segments 48 that the first anode power supply brush 81 and the second anode power supply brush 82 come into contact are the two segments 48 short-circuited by the short-circuiting member 51 and correspond to the number “2” and “10” segments 48 in the state illustrated in FIG. 13. Further, the condition “θ1=θ3, and θ2=θ4” is satisfied. In this case, the time at which the first anode power supply brush 81 and the second anode power supply brush 82 starts to contact the subsequent segment 48 is the same as the time at which the first anode power supply brush 81 and the second anode power supply brush 82 ends contact with the present segment 48. Thus, the commutation starting time and the commutation ending time of the coils 44 with the first anode power supply brush 81 and the commutator 45 are the same as the commutation starting time and the commutation ending time of the coils 44 with the second anode power supply brush 82 and the commutator 45.

The first cathode power supply brushes 83 and the second cathode power supply brush 84, which are cathode power supply brushes, have similar configurations. More specifically, the deviation angle between the rear ends of the first cathode power supply brush 83 and the second cathode power supply brush 84 in the rotation direction R (angle between rear ends) is equal to the deviation angle between the rear ends of the two segments in the rotation direction R (angle between rear ends) that the power supply brushes 83 and 84 come into contact with (segments 48 short-circuited by short-circuiting member 51). Moreover, the deviation angle between the front ends of the first cathode power supply brush 83 and the second cathode power supply brush 84 in the rotation direction R (angle between front ends) is equal to the deviation angle between the front ends of the two segments in the rotation direction R (angle between front ends) that the power supply brushes 83 and 84 come into contact with.

In the example illustrated in FIG. 13, the commutation starting time and the commutation ending time is the same for each coil 44 of the two power supply brushes 64 in both of the anode and the cathode. However, the configuration illustrated in the example of FIG. 13 may be applied to only the power supply brushes 64 of the anode (i.e., first anode power supply brush 81 and second anode power supply brush 82) or only the power supply brushes 64 of the cathode (i.e., first cathode power supply brush 83 and second cathode power supply brush 84).

The examples described above have advantage (1) of the first embodiment. Further, only the power supply brushes need to be changed. Thus, except for the power supply brushes, the components of a conventional motor (e.g., motor including a power supply brushes having uniform electric resistance) can be used. Accordingly, the manufacturing costs of the motor can be reduced. The above examples may be applied to the second through seventh embodiments and obtain the same advantages.

In the first embodiment, the first anode power supply brush 81 and the second anode power supply brush 82 of the anode simultaneously come into contact with the segments 48 adjacent to the segment 48 that the first anode power supply brush 81 and the second anode power supply brush 82 are presently in contact with. In addition, the first anode power supply brush 81 and the second anode power supply brush 82 are simultaneously separated from the segments 48. However, the first anode power supply brush 81 and the second anode power supply brush 82 are not required to simultaneously (i.e., at the same time) come into contact with the segments 48 adjacent to the segments 48 that the first anode power supply brush 81 and the second anode power supply brush 82 are presently in contact with. In the same manner, the first anode power supply brush 81 and the second anode power supply brush 82 are not required to be simultaneously separated from the segments 48. The same applies to the first cathode power supply brush 83 and the second cathode power supply brush 84. In the same manner, the same applies to the second and the fourth through seventh embodiments.

In the first embodiment, the middle of the second anode power supply brush 82, which has the same polarity as the first anode power supply brush 81 in the rotation direction R, is located at the middle of the segment 48 in the rotation direction R that the second anode power supply brush 82 is sliding on when the middle of the first anode power supply brush 81 in the rotation direction R is located at the middle of the segment 48 that the first anode power supply brush 81 is sliding on. In the same manner, the middle of the second cathode power supply brush 84, which has the same polarity as the first cathode power supply brush 83, in the rotation direction R is located at the middle of the segment 48 in the rotation direction R that the second cathode power supply brush 84 is sliding on when the middle of the first cathode power supply brush 83 in the rotation direction R is located at the middle of the segment 48 in the rotation direction R that the first cathode power supply brush 83 is sliding on. However, the power supply brushes 81 to 83 may be located at other positions. This is also applicable to the second and the fourth through seventh embodiments.

In the embodiments described above, the electric resistance of each of the second anode power supply brushes 82, 112, and 142 and the second cathode power supply brushes 84, 114, and 144 is equal to the electric resistance of the high-resistance portions 91. However, the electric resistance of each of the second anode power supply brushes 82, 112, and 142 and the second cathode power supply brushes 84, 114, and 144 may differ from the electric resistance of the high-resistance portions 91. For example, the electric resistance of the high-resistance portions 91 may be larger than the electric resistance of each of the second anode power supply brushes 82, 112, and 142 and the second cathode power supply brushes 84, 114, and 144. In this case, for example, the sintering time is changed so that the electric resistance of each of the second anode power supply brushes 82, 112, and 142 and the second cathode power supply brushes 84, 114, and 144 differs from the electric resistance of the high-resistance portions 91. As a result, the electric resistance of each of the second anode power supply brushes 82, 112, and 192 and the second cathode power supply brushes 84, 114, and 144 is smaller than the electric resistance of each of the high-resistance portions 91 of the first anode power supply brushes 81, 101, 111, 121, and 141a, 141b and the first cathode power supply brushes 83, 103, 113, 123, 143a, and 143b. Accordingly, current also flows to the second anode power supply brushes 82, 112, 142 and the second cathode power supply brushes 84, 114, and 144 in contrast with the case in which the electric resistance of each of the second anode power supply brushes 82, 112, and 142 and the second cathode power supply brushes 84, 114, and 144 is equal to the electric resistance of each of the high-resistance portions 91. At the same time, the flow of a large current is limited in the low-resistance portions 92 that have a smaller electric resistance than the high-resistance portions 91 in the first anode power supply brushes 81, 101, 111, 121, 141a, and 141b and the first cathode power supply brushes 83, 103, 113, 123, 143a, and 143b. This further limits the shortening of the life of the first anode power supply brushes 81, 101, 111, 121, 141a, and 141b and the first cathode power supply brushes 83, 103, 113, 123, 143a, and 143b. Further, in this case, the electric resistance of each of the second anode power supply brushes 82, 112, and 142 and the second cathode power supply brushes 84, 114, and 144 is larger than the electric resistance of each of the low-resistance portions 92 of the first anode power supply brushes 81, 101, 111, 121, and 141a, 141b, and the first cathode power supply brushes 83, 103, 113, 123, 143a, and 143b. This reduces the generation of large sparks from the second anode power supply brushes 82, 112, and 142 and the second cathode power supply brushes 84, 114, and 144 when the second anode power supply brushes 82, 112, and 142 and the second cathode power supply brushes 84, 114, and 144 are separated from the segments 48.

In the first through fourth, sixth, and seventh embodiments, each of the first anode power supply brushes 81, 101, 111, 141a, and 141b and the first cathode power supply brushes 83, 103, 113, 143a, and 143b has a two-layer laminate structure including the two brush layers of the high-resistance portion 91 and the low-resistance portion 92 that are overlapped with each other in the rotation direction R. In the fifth embodiment, each of the first anode power supply brush 121 and the first cathode power supply brush 123 has a three-layer laminate structure including the three brush layers of the two high-resistance portions 91 and the one low-resistance portion 92 that are overlapped with one another in the rotation direction R. However, the number of the brush layers in each of the power supply brushes 81, 101, 111, 121, 141a, 141b, 83, 103, 113, 123, 143a, and 143b is not limited to such a manner. Each of the power supply brushes 81, 101, 111, 121, 141a, 141b, 83, 103, 113, 123, 143a, and 143b may have any configuration as long as a plurality of brush layers having different electric resistances are laminated in the rotation direction R. For example, each of the low-resistance portions 92 of the power supply brushes 81, 101, 111, 121, 141a, 141b, 83, 103, 113, 123, 143a, and 143b may have a laminate structure formed by a plurality of brush layers having a smaller electric resistance than the high-resistance portions 91 and overlapped with one another in the rotation direction R.

In each of the above embodiments, each of the first anode power supply brushes 81, 101, 111, 121, 141a, and 141b and the first cathode power supply brushes 83, 103, 113, 123, 143a, and 143b is a laminate brush having a laminate structure that includes the high-resistance portion 91 and the low-resistance portion 92 overlapped with each other in the rotation direction R. However, each of the first anode power supply brushes 81, 101, 111, 121, 141a, and 141b and the first cathode power supply brushes 83, 103, 113, 123, 143a, and 143b does not have to be a laminate structure. Each of the first anode power supply brushes 81, 101, 111, 121, 141a, and 141b, and the first cathode power supply brushes 83, 103, 113, 123, 143a, and 143b may have any configuration as long as the electric resistance is varied in the rotation direction R so that the high-resistance portion 91 is located in the portion including the front end of each power supply brush in the rotation direction R and so that the low-resistance portion 92 is located next to the high-resistance portion 91 in the rotation direction R and has a smaller electric resistance than the high-resistance portion 91. For example, each of the first anode power supply brushes 81, 101, 111, 121, 141a, and 141b and the first cathode power supply brushes 83, 103, 113, 123, 193a, and 143b may be configured so that the electric resistance gradually increases in the rotation direction R from the rear end of the power supply brush toward the front end of the power supply brush in the rotation direction R.

In the first embodiment, each of the first anode power supply brush 81 and the first cathode power supply brush 83 is configured so that in a cross section orthogonal to the radial direction, the high-resistance portion 91 has a quadrangular shape and is located at the front side with respect to the rotation direction R and the low-resistance portion 92 has a quadrangular shape similar to that of the high-resistance portion 91 and is located at the rear side with respect to the rotation direction R. However, each of the first anode power supply brush 81 and the first cathode power supply brush 83 may have any configuration as long as the electric resistance is varied in the rotation direction R by the high-resistance portion 91, in the portion including the front end of the power supply brush 81 or 83 with respect to the rotation direction R, and the low-resistance portion 92, located next to the high-resistance portion 91 in the rotation direction R and having a smaller electric resistance than the high-resistance portion 91. This also applies to the first anode power supply brushes, 101, 111, 121, 141a, and 141b and the first cathode power supply brushes 103, 113, 123, 143a, and 143b of the second through seventh embodiments.

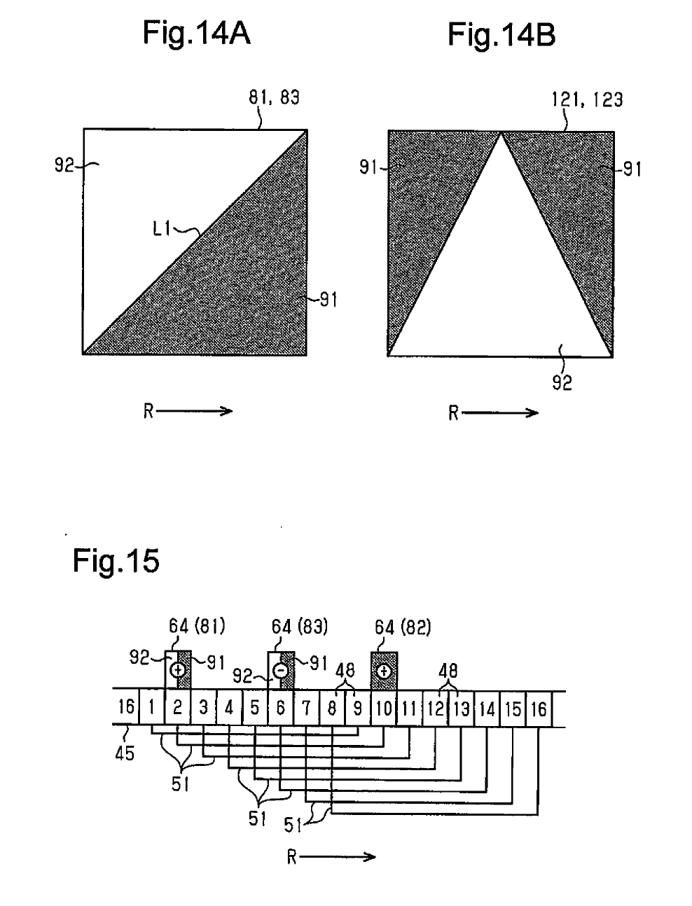

For example, as illustrated in FIG. 14A, each of the first anode power supply brush 81 and the first cathode power supply brush 83 may be configured so that in a cross section orthogonal to the radial direction, the high-resistance portion 91 has a triangular shape occupying a front side of a diagonal L1 with respect to the rotation direction R and the low-resistance portion 92 has a triangular shape occupying a rear side of the diagonal L1 with respect to the rotation direction R in the same cross section. FIG. 14A does not use hatching to show a cross section. The cross-sectional shape of each of the first anode power supply brush 81 and the first cathode power supply brush 83 is uniform in the radial direction. Each of the first anode power supply brush 81 and the first cathode power supply brush 83 has a multilayer structure that includes two brush layers (i.e., high-resistance portion 91 and the low-resistance portion 92) having different electric resistances and overlapped with each other in the rotation direction R.

For example, each of the first anode power supply brush 121 and the first cathode power supply brush 123 of the fifth embodiment may have a configuration illustrated in FIG. 14B. FIG. 14B does not use hatching to show a cross section. In the example illustrated in FIG. 14B, in a cross section orthogonal to the radial direction of the first anode power supply brush 121 and the first cathode power supply brush 123, each low-resistance portion 92 has a triangular shape at a central portion of the power supply brush 121 or 123 in the rotation direction R. In the same cross section, each of the two high-resistance portions 91 has a triangular shape and occupies the region at the two sides of the low-resistance portion 92 in the rotation direction R. The low-resistance portion 92 in the same cross section has the shape of an isosceles triangle including a base that is the side in the direction orthogonal to the rotation direction R, and the two high-resistance portions 91 each have the shape of a right triangle. The hypotenuses of the right triangles are equal in length. The cross-sectional shape each of the first anode power supply brush 121 and the first cathode power supply brush 123 is uniform in the radial direction. Each of the first anode power supply brush 121 and the first cathode power supply brush 123 has a multilayer structure which includes the low-resistance portion 92 and the two high-resistance portions 91 having different electric resistances and overlapped with each other in the rotation direction R. A bidirectional rotation motor including the first anode power supply brush 121 and the first cathode power supply brush 123 of this configuration has advantage (1) of the first embodiment regardless of the motor rotation direction.

In the first embodiment, the motor 31 includes a total of four power supply brushes including the two power supply brushes 64 of the anode (first anode power supply brush 81 and second anode power supply brush 82) and the two power supply brushes 64 of the cathode (first cathode power supply brush 83 and second cathode power supply brush 84). However, the motor 31 may include any number of the power supply brushes 64 as long as at least either one of the anode and the cathode include a multiple number of poles.

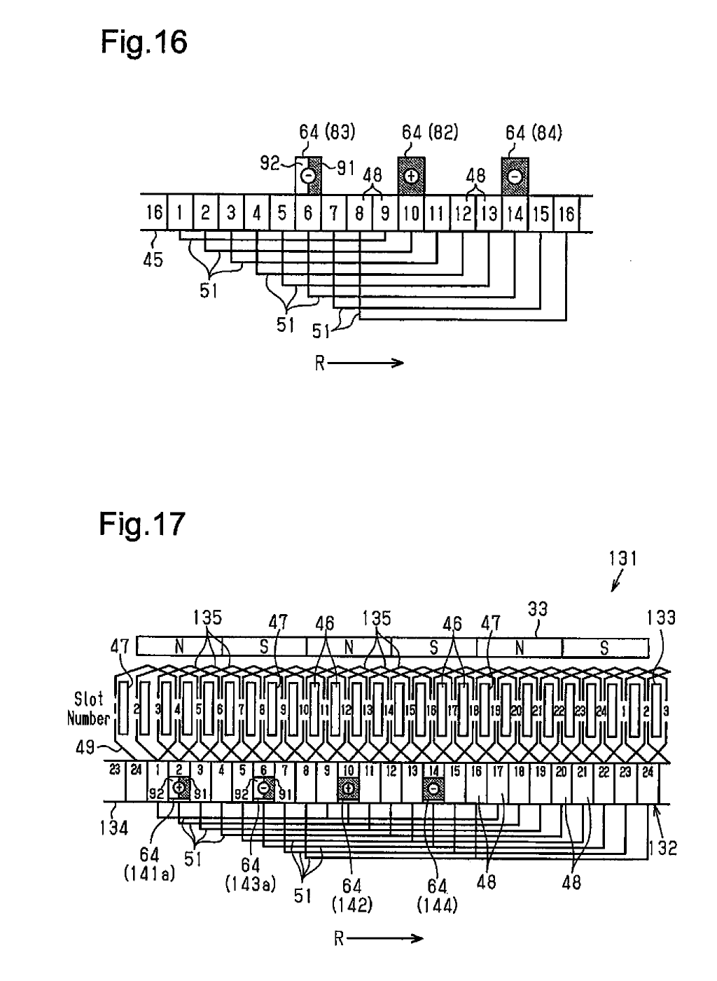

For example, as illustrated in FIG. 15, the motor may include a total of three power supply brushes including the first anode power supply brush 81, the first cathode power supply brush 83, and the second anode power supply brush 82. In the example illustrated in FIG. 15, the power supply brushes 81 to 83 are located at the same positions as the first embodiment. Further, for example, as illustrated in FIG. 16, the motor may include a total of three power supply brushes including the first cathode power supply brush 83, the second anode power supply brush 82, and the second cathode power supply brush 89. In the example illustrated in FIG. 16, the power supply brushes 82 and 8 are located at the same positions as the first embodiment. The number of the power supply brushes 64 in the second through fifth embodiments may be changed in the same manner.

For example, as illustrated in FIG. 17, the first anode power supply brush 141b and the first cathode power supply brush 143b may be omitted from the motor 131 of the sixth embodiment. In the example illustrated in FIG. 17, the first cathode power supply brush 143a is arranged at a position shifted from the first anode power supply brush 141a by 60 degrees in the rotation direction R, and the second anode power supply brush 142 is arranged at a position shifted from the first cathode power supply brush 143a by 60 degrees in the rotation direction R. The second cathode power supply brush 144 is arranged at a position shifted from the second anode power supply brush 142 by 60 degrees in the rotation direction R. In the same manner, the number of the power supply brushes 64 may also be changed in the motor of the seventh embodiment so that at least either one of the anode and the cathode includes a multiple number of the power supply brushes 64.

The above example decreases the number of the power supply brushes 64. This reduces the manufacturing costs of the motor. The reduction in the number of parts facilitates the coupling of the power supply brushes 64.

In each of the above embodiments, the high-resistance portion 91 is formed by sintering a material of which the main component is carbon (C), and the low-resistance portion 92 is formed by sintering a material of which the main components are copper (Cu) and carbon (C). However, the materials of the high-resistance portion 91 and the low-resistance portion 92 are not limited. The high-resistance portion 91 and the low-resistance portion 92 may be formed from any material as long as the electric resistance of the low-resistance portion 92 is smaller than the electric resistance of the high-resistance portion 91. The low-resistance portions 92 is formed so that the electric resistance is lower than the second anode power supply brushes 82, 112, and 142 and the second cathode power supply brushes 84, 114, and 144.

The positions where the power supply brushes 64 are located are not limited to the positions of the above embodiments and may be changed.

The numbers of the segments 48, the coils 44, 135, and 155, and the poles of the magnets 33 may be changed in the above embodiments.

### Eighth Embodiment

A motor according to an eighth embodiment will now be described. Same reference numerals are given to those components that are the same as the corresponding components of the first embodiment. Such components will not be described in detail.

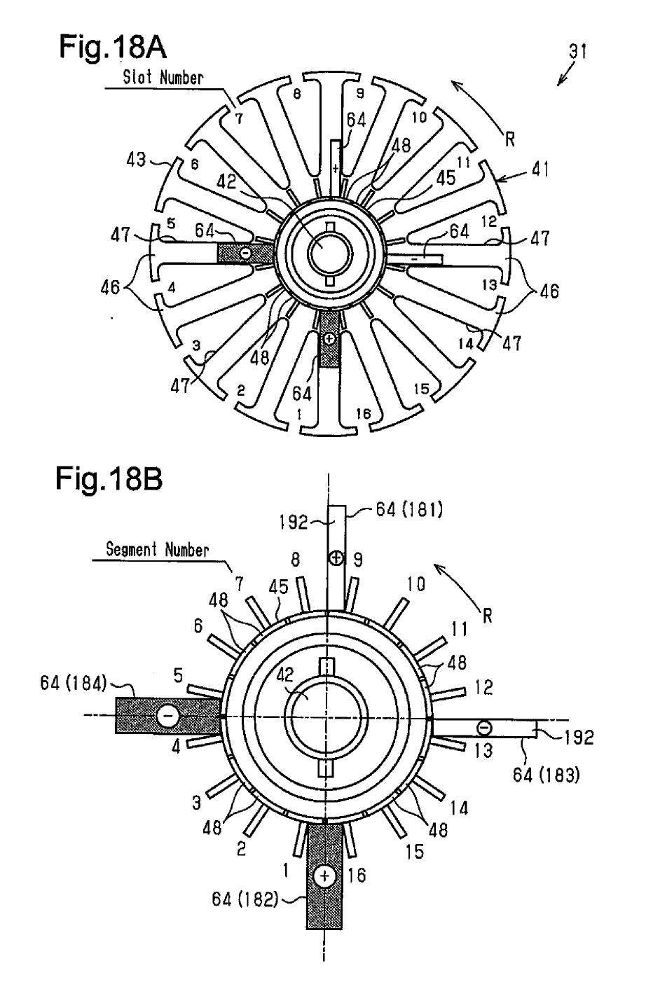

The power supply brushes 64 of the present embodiment will now be described in detail. As illustrated in FIG. 3 and FIGS. 18 to 20, the four power supply brushes 64 held by the brush holding portions 63 are spaced apart from each other in the rotation direction R.

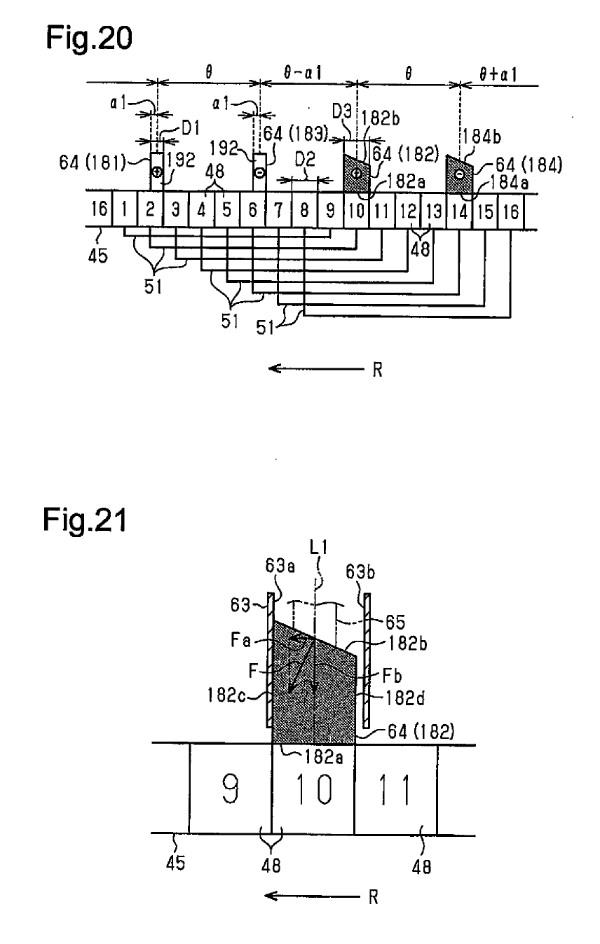

As illustrated in FIG. 20, two of the four power supply brushes 64 define a first anode power supply brush 181 and a second anode power supply brush 182 of the anode. The two remaining power supply brushes 64 define a first cathode power supply brush 183 and a second cathode power supply brush 184 of the cathode. The four power supply brushes 64 are arranged in the order of the second cathode power supply brush 184, the second anode power supply brush 182, the first cathode power supply brush 183, and the first anode power supply brush 181 in the rotation direction R. In the present embodiment, the first anode power supply brush 181 and the first cathode power supply brush 183 have the same external shape, and the second anode power supply brush 182 and the second cathode power supply brush 184 have the same external shape.

Each of the first anode power supply brush 181 and the first cathode power supply brush 183 has a constant electric resistance (i.e., electric resistance is not varied) in the rotation direction R. Each of the second anode power supply brush 182 and the second cathode power supply brush 184 has a constant electric resistance (i.e., electric resistance is not varied) in the rotation direction R. The second anode power supply brush 182 and the second cathode power supply brush 184 has a larger electric resistance than the first anode power supply brush 181 and the first cathode power supply brush 183. Accordingly, the first anode power supply brush 181 and the first cathode power supply brush 183 each entirely defines a low-resistance portion 192 having a smaller electric resistance than the second anode power supply brush 182 and the second cathode power supply brush 184. For example, each of the first anode power supply brush 181 and the first cathode power supply brush 183 is formed by sintering a material of which the main components are copper (Cu) and carbon (C). For example, each of the second anode power supply brush 182 and the second cathode power supply brush 189 is formed by sintering a material of which the main component is carbon (C).

The width D1 of each the first anode power supply brush 181 and the first cathode power supply brush 183 in the rotation direction R is smaller than the width D2 of each segment 48 in the rotation direction R. In the present embodiment, the width D1 of the first anode power supply brush 181 and the first cathode power supply brush 183 in the rotation direction R is one half of the width D2 of each segment 48 in the rotation direction R. The width D3 of each of the second anode power supply brush 182 and the second cathode power supply brush 184 in the rotation direction R is equal to the width D2 of each segment 48 in the rotation direction R.

The second anode power supply brush 182 is arranged at a position shifted from the second cathode power supply brush 184 by an angle θ in the rotation direction R. The first cathode power supply brush 183 is arranged at a position shifted from the second anode power supply brush 182 by an angle (θ−α1) in the rotation direction R, that is, a position shifted from the second cathode power supply brush 184 by an angle (2θ−α1) in the rotation direction R. The first anode power supply brush 181 is arranged at a position shifted from the first cathode power supply brush 183 by the angle θ in the rotation direction R, that is, a position shifted from the second anode power supply brush 182 by an angle (2θ−α1) in the rotation direction R. The first anode power supply brush 181 and the second cathode power supply brush 184 are shifted from each other by an angle (θ+α1) in the rotation direction R. In the present embodiment, the angle θ is set to 90 degrees. The angle α1 is an angle set beforehand and corresponds to one half of the width D1 of each of the first anode power supply brush 181 and the first cathode power supply brush 183 in the rotation direction R in the present embodiment.

The two power supply brushes 64 of the anode are arranged so that the rear end of the second anode power supply brush 182 in the rotation direction R is located at the rear end of a segment 48 in the rotation direction R when the rear end of the first anode power supply brush 181 in the rotation direction R is located at the rear end of a segment 48 in the rotation direction R. In the same manner, the two power supply brushes 64 of the cathode are arranged so that the rear end of the second cathode power supply brush 184 in the rotation direction R is located at the rear end of a segment 48 in the rotation direction R when the rear end of the first cathode power supply brush 183 in the rotation direction R is located at the rear end of a segment 48 in the rotation direction R. For example, as illustrated in FIG. 20, when the rear end of the first anode power supply brush 181 in the rotation direction R is located at the rear end of the number “2” segment 48 in the rotation direction R, the rear end of the second anode power supply brush 182 in the rotation direction R is located at the rear end of the number “10” segment 48 in the rotation direction R. When the second anode power supply brush 182 contacts only the number “10” segment 48, the first anode power supply brush 181 contacts only the number “2” segment 48, which is short-circuited with the number “10” segment 48. When the rear end of the first cathode power supply brush 183 in the rotation direction R is located at the rear end of the number “6” segment 48 in the rotation direction R, the rear end of the second cathode power supply brush 184 in the rotation direction R is located at the rear end of the number “14” segment 48 in the rotation direction R. When the second cathode power supply brush 184 contacts only the number “14” segment 48, the first cathode power supply brush 183 contacts only the number “6” segment 48, which is short-circuited with the number “14” segment 48. In this manner, each of the power supply brushes 64 is arranged to simultaneously contact the segment 48 adjacent to the segment 48 that the power supply brush 64 is presently in contact with. Thus, all of the power supply brushes 64 are arranged to contact the subsequent segments 48 at the same timing.

When the positions and widths of the four power supply brushes 64 in the rotation direction R are set as described above, the commutation ending time (time separated from segments 48) of the second anode power supply brush 182 and the second cathode power supply brush 184 is delayed by a predetermined time from the commutation ending time of the first anode power supply brush 181 and the first cathode power supply brush 183. In this case, as described above, the first anode power supply brush 181 and the second anode power supply brush 182, which have the same polarity, contact the segments 48, which are short-circuited by the short-circuiting member 51. In the same manner, the first cathode power supply brush 183 and the second cathode power supply brush 184, which have the same polarity, contact the segments 48, which are short-circuited by the short-circuiting member 51. Thus, the power supply brushes 181 to 184 commutate the same coil 44.

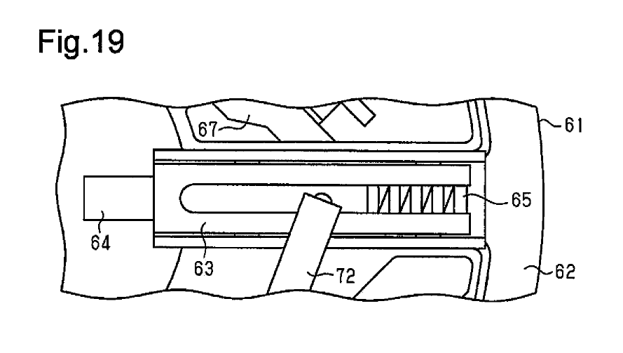

As illustrated in FIGS. 19 and 20, a rear end surface 182b of the second anode power supply brush 182 (end surface at side opposite to distal end surface 182a that contacts commutator 45) and a rear end surface 184b of the second cathode power supply brush 184 (end surface at side opposite to distal end surface 184a that contacts commutator 45) are inclined to direct a vector of an urging force F produced by an urging member 65 toward the front in the rotation direction R. The second cathode power supply brush 184 has the same external shape as the external shape of the second anode power supply brush 182. Accordingly, only the shape of the second anode power supply brush 182 will be described, and the shape of the second cathode power supply 184 will not be described.

As illustrated in FIG. 21, the two side surfaces 182c and 182d of the second anode power supply brush 182 in the rotation direction R extend parallel to each other. The two side surfaces 182c and 182d of the second anode power supply brush 182 are parallel to the diametrical direction of the commutator 45 as viewed in the axial direction of the rotation shaft 42 (see FIG. 1). The brush holding portion 63 accommodating the second anode power supply brush 182 includes two inner surfaces 63a and 63b facing each other in the rotation direction R and spaced apart by a distance that is slightly greater than the width of the second anode power supply brush 182 in the rotation direction R. Further, the two inner surfaces 63a and 63b are parallel to the diametrical direction of the commutator 45 as viewed in the axial direction of the rotation shaft 42 (see FIG. 1). Inside the brush holding portion 63, the side surface 182c of the second anode power supply brush 182 and the inner surface 63a of the brush holding portion 63 face each other in the rotation direction R, and the side surface 182d of the second anode power supply brush 182 and the inner surface 63b of the brush holding portion 63 face each other in the rotation direction R.

The rear end surface 182b of the second anode power supply brush 182 is planar and inclined to approach the outer circumferential surface of the commutator 45 from the side surface 182c, which is located at the front side of the second anode power supply brush 182 in the rotation direction R, toward the side surface 182d, which is located at the rear side of the second anode power supply brush 182 in the rotation direction R. The urging member 65, which urges the second anode power supply brush 182 toward the commutator 45, urges the rear end surface 182b toward the commutator 45. Since the urging member 65 urges the rear end surface 182b of the second anode power supply brush 182 toward the commutator 45, the vector of the urging force F of the urging member 65 is directed toward the front side in the rotation direction R. More specifically, the vector of the urging force F is directed toward the front side of a line L1 in the rotation direction R. Further, the line L1 extends through the middle of the second anode power supply brush 182 in the rotation direction R and is orthogonal to the rotation direction R.

The operation of the present embodiment will now be described.

Generally, a power supply brush generates sparks when starting to contact a segment and when starting to separate from the segment. In particular, a large spark is produced when the power supply brush is separated from the segment. Such a spark greatly advances wear of the power supply brush. In the motor of the present embodiment, the first anode power supply brush 181 and the second anode power supply brush 182, which are of the same polarity, are configured so that with regard to segments 48 at which the potential is the same, the separation of the second anode power supply brush 182 is later than the separation of the first anode power supply brush 181. Further, the first cathode power supply brush 183 and the second cathode power supply brush 184, which are of the same polarity, are configured so that with regard to segments 48 at which the potential is the same, the separation of the second cathode power supply brush 184 is later than the separation of the first cathode power supply brush 183. Thus, only the second anode power supply brush 182 and the second cathode power supply brush 184, which are separated from the segments 48 at a later timing, generate sparks when separated from the segments 48. In other words, sparks are produced only when the second anode power supply brush 182 and the second cathode power supply brush 184, each of which has a larger electric resistance than each of the first anode power supply brush 181 and the first cathode power supply brush 183, are separated from the segments 48. When the second anode power supply brush 182 and the second cathode power supply brush 184 are separated from the segment 48 of the rotating commutator 45, sparks are produced at the front ends of the second anode power supply brush 182 and the second cathode power supply brush 184 in the rotation direction R.

The rear end surface 182b of the second anode power supply brush 182 and the rear end surface 184b of the second cathode power supply brush 184 are each inclined so the vector of the urging force F produced by the urging member 65 is directed toward the front in the rotation direction R. Thus, as illustrated in FIG. 21, when the urging member 65 urges the rear end surface 182b of the second anode power supply brush 182 toward the commutator 45, a component force Fa is produced in the rotation direction R to press the second anode power supply brush 182 toward the front in the rotation direction R. The second anode power supply brush 182 pressed by the component force Fa toward the front in the rotation direction R presses the side surface 182c in the front side of the second anode power supply brush 182 in the rotation direction R against the inner surface 63a located at the front of the brush holding portion 63 in the rotation direction R. The second anode power supply brush 182 is movable in a direction orthogonal to the rotation direction R (direction from rear end toward distal end of second anode power supply brush 182) while guided by the inner surface 63a located at the front of the brush holding portion 63 in the rotation direction R. The urging force F of the urging member 65 further produces a component force Fb in the direction orthogonal to the rotation direction R. In this case, the component force Fb presses the second anode power supply brush 182 against the outer circumferential surface of the commutator 45 (segment 48). As a result, the front end of the second anode power supply brush 182 in the rotation direction R, that is, the end separated from the segment 48, stably contacts the segment 48.

The second cathode power supply brush 189 has the same external shape as the second anode power supply brush 182. Thus, the second cathode power supply brush 184 functions in the same manner.

The advantages of the present embodiment will now be described.

(12) If sparks are produced when the second anode power supply brush 182 and the second cathode power supply brush 184 are separated from the segments 48 of the rotating commutator 45, the sparks will be produced from the front ends of the second anode power supply brush 182 and the second cathode power supply brush 184 in the rotation direction R, that is, the ends of the power supply brushes 182 and 184 separated from the segments 48. The rear end surface 182b of the second anode power supply brush 182 and the rear end surface 184b of the second cathode power supply brush 184 are each inclined to direct the vector of the urging force F produced by the urging member 65 toward the front in the rotation direction R. Thus, the second anode power supply brush 182 and the second cathode power supply brush 184 are each pressed against the brush holding portion 63 toward the front in the rotation direction R by the urging force F of the urging member 65 (component force Fa). This limits loosening of the front ends of the second anode power supply brush 182 and the second cathode power supply brush 184 in the rotation direction R during rotation of the commutator 45. Accordingly, the separation of the first anode power supply brush 181 from the segment 48 at a timing later than the second anode power supply brush 182 because of the loosening of the second anode power supply brush 182 is restricted. As a result, among the power supply brushes 64, the generation of sparks is limited at the first anode power supply brush 181 and the first cathode power supply brush 183 that have a smaller electric resistance than the second anode power supply brush 182 and the second cathode power supply brush 184. This limits the shortening of the life of the first anode power supply brush 181 and the first cathode power supply brush 183, each having a smaller electric resistance than the second anode power supply brush 182 and the second cathode power supply brush 184.

(13) The first anode power supply brush 181 and the first cathode power supply brush 183 in the rotation direction Reach entirely define the low-resistance portion 192, which has a smaller electric resistance than the second anode power supply brush 182 and the second cathode power supply brush 184, and has a constant electric resistance in the rotation direction R. Thus, the manufacturing of the first anode power supply brush 181 and the first cathode power supply brush 183 is facilitated. Even though the motor 31 includes the first anode power supply brush 181 and the first cathode power supply brush 183, the first anode power supply brush 181 will not be separated from a segment 48 at a later timing than the second anode power supply brush 182 because of the looseness of the second anode power supply brush 182, and the first cathode power supply brush 183 will not be separated from the segment 48 at a later timing than the second cathode power supply brush 184 because of the looseness of the second cathode power supply brush 184. Accordingly, the generation of sparks is limited at the entire first anode power supply brush 181 and the entire first cathode power supply brush 183 that have a smaller electric resistance than the second anode power supply brush 182 and the second cathode power supply brush 184. This limits the shortening of the life of each of the first anode power supply brush 181 and the first cathode power supply brush 183 in the same manner as a configuration in which the electric resistance of the entire first anode power supply brush 181 and the entire first cathode power supply brush 183 is smaller than the second anode power supply brush 182 and the second cathode power supply brush 184.

(14) The second anode power supply brush 182 is arranged to be separated from a segment 48 at a later timing than the first anode power supply brush 181, which has the same polarity as the second anode power supply brush 182. In the same manner, the second cathode power supply brush 184 is arranged to be separated from the segment 48 at a later timing than the first cathode power supply brush 183, which has the same polarity as second cathode power supply brush 184. Thus, the separation from the segments 48 produces sparks only from the second anode power supply brush 182 and the second cathode power supply brush 189 that are separated from the segments 48 at a later timing. This reduces the sparks produced between the segments 98 and the first anode power supply brush 181 and first cathode power supply brush 183, which have a smaller electric resistance than the second anode power supply brush 182 and second cathode power supply brush 184. Accordingly, shortening of the life of the first anode power supply brush 181 and the first cathode power supply brush 183 is limited. Furthermore, the electric resistance of each of the second anode power supply brush 182 and the second cathode power supply brush 184 is larger than the first anode power supply brush 181 and the first cathode power supply brush 183. This reduces large sparks that are produced when the second anode power supply brush 182 and the second cathode power supply brush 184 are separated from the segments 48. Accordingly, shortening of the life of the second anode power supply brush 182 and the second cathode power supply brush 184 resulting from spark wear is limited even in a structure that produces sparks when the second anode power supply brush 182 and the second cathode power supply brush 184 are separated from the segments 48.

### Ninth Embodiment

A motor according to a ninth embodiment will now be described. Same reference numerals are given to those components that are the same as the corresponding components of the eighth embodiment. Such components will not be described in detail.

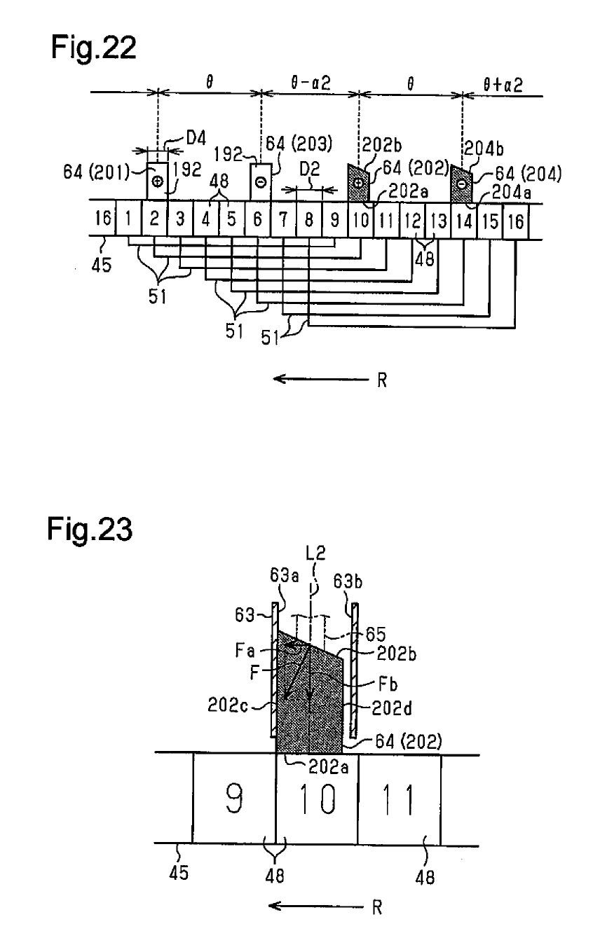

As illustrated in FIG. 22, the motor includes a first anode power supply brush 201 and a second anode power supply brush 202 instead of the first anode power supply brush 181 and the second anode power supply brush 182 of the eighth embodiment. In the same manner, the motor includes a first cathode power supply brush 203 and a second cathode power supply brush 204 instead of the first cathode power supply brush 183 and the second cathode power supply brush 184 of the eighth embodiment. The first anode power supply brush 201 and the first cathode power supply brush 203 have the same external shape, and the second anode power supply brush 202 and the second cathode power supply brush 204 have the same external shape. The power supply brushes 201 to 204 all have a uniform width D4 in the rotation direction R. FIG. 22 illustrates the width D4 in the rotation direction R only for the first anode power supply brush 201 as a representative example. In the present embodiment, the width D4 of each of the power supply brushes 201 to 204 in the rotation direction R is smaller than the width D2 of the segments 48 in the rotation direction R and larger than one half of the width D2 of each of the segments 48 in the rotation direction R.

The first anode power supply brush 201 and the first cathode power supply brush 203 each have a constant electric resistance (i.e., electric resistance is not varied) in the rotation direction R. The second anode power supply brush 202 and the second cathode power supply brush 204 each have a constant electric resistance (i.e., electric resistance is not varied) in the rotation direction R. The electric resistance of the second anode power supply brush 202 and the second cathode power supply brush 204 is larger than the electric resistance of the first anode power supply brush 201 and the first cathode power supply brush 203. More specifically, the first anode power supply brush 201 and the entire first cathode power supply brush 203 each entirely defines the low-resistance portion 192 having a smaller electric resistance than each of the second anode power supply brush 202 and the second cathode power supply brush 204.

The second anode power supply brush 202 is arranged at a position shifted from the second cathode power supply brush 204 by an angle θ in the rotation direction R. The first cathode power supply brush 203 is arranged at a position shifted from the second anode power supply brush 202 by an angle (θ−α2) in the rotation direction R, that is, at a position shifted from the second cathode power supply brush 204 by an angle (2θ−α2) in the rotation direction R. The first anode power supply brush 201 is arranged at a position shifted from the first cathode power supply brush 203 by an angle θ in the rotation direction R, that is, at a position shifted from the second anode power supply brush 202 by an angle (2θ−α2) in the rotation direction R. The first anode power supply brush 201 and the second cathode power supply brush 204 are shifted from each other by an angle (θ+α2) in the rotation direction R. In the present embodiment, the angle θ is set to 90 degrees. The angle α2 is an angle set beforehand.

The two power supply brushes 64 of the anode are arranged so that the front end of the second anode power supply brush 202 in the rotation direction R is located at the front end of the segment 48 in the rotation direction R when the rear end of the first anode power supply brush 201 in the rotation direction R is located at the rear end of the segment 48 in the rotation direction R. In the same manner, the two power supply brushes 64 of the cathode are arranged so that the front end of the second cathode power supply brush 204 in the rotation direction R is located at the front end of the segment 48 in the rotation direction R when the rear end of the first cathode power supply brush 203 in the rotation direction R is located at the rear end of the segment 48 in the rotation direction R. For example, as illustrated in FIG. 22, when the rear end of the first anode power supply brush 201 in the rotation direction R is located at the rear end of the number “2” segment 48 in the rotation direction R, the front end of the second anode power supply brush 202 in the rotation direction R is located at the front end of the number “10” segment 48 in the rotation direction R. When the second anode power supply brush 202 contacts only the number “10” segment 48, the first anode power supply brush 201 contacts only the number “2” segment 48 that is short-circuited with the number “10” segment 48. When the rear end of the first cathode power supply brush 203 in the rotation direction R is located at the rear end of the number “6” segment 48 in the rotation direction R, the front end of the second cathode power supply brush 204 in the rotation direction R is located at the front end of the number “14” segment 48 in the rotation direction R. When the second cathode power supply brush 204 contacts only the number “14” segment 48, the first cathode power supply brush 203 contacts only the number “6” segment 48 that is short-circuited with the number “14” segment 48.

When the positions and widths of the four power supply brushes 201 to 204 in the rotation direction R are set as described above, the commutation ending time (time separated from segments 48) of the second anode power supply brush 202 and the second cathode power supply brush 204 is delayed by a predetermined time from the commutation ending time of the first anode power supply brush 201 and the first cathode power supply brush 203. In this case, as described above, the first anode power supply brush 201 and the second anode power supply brush 202, which have the same polarity, contact the segments 48 short-circuited by the short-circuiting member 51. In the same manner, the first cathode power supply brush 203 and the second cathode power supply brush 209, which have the same polarity, contact the segments 48 short-circuited by the short-circuiting member 51. Accordingly, the power supply brushes 201 to 204 commutate the same coil 44. Since the commutation ending time of the second anode power supply brush 202 and the second cathode power supply brush 204 is delayed by the predetermined period from that of the first anode power supply brush 201 and the first cathode power supply brush 203, sparks are produced only from the high-resistance second anode power supply brush 202 and the second cathode power supply brush 204 when separated from the segments 48.

As illustrated in FIGS. 22 and 23, a rear end surface 202b of the second anode power supply brush 202 (end surface at side opposite to distal end surface 202a that contacts commutator 45) and a rear end surface 204b of the second cathode power supply brush 204 (end surface at side opposite to distal end surface 204a that contacts commutator 45) is inclined to direct the vector of the urging force F produced by the urging member 65 toward the front in the rotation direction R. The second cathode power supply brush 204 has the same external shape as the external shape of the second anode power supply brush 202. Thus, only the shape of the second anode power supply brush 202 will described herein, and the shape of the second cathode power supply 204 will not be described.

The two side surfaces 202c and 202d of the second anode power supply brush 202 in the rotation direction R extend parallel to each other. The second anode power supply brush 202 is arranged so that the two side surfaces 202c and 202d are parallel to the diametrical direction of the commutator 45 as viewed in the axial direction of the rotation shaft 42 (see FIG. 1). The brush holding portion 63 accommodating the second anode power supply brush 202 includes two inner surfaces 63a and 63b facing each other in the rotation direction R and spaced apart by a distance that is slightly greater than the width of the second anode power supply brush 182 in the rotation direction R. Inside the brush holding portion 63, the side surface 202c of the second anode power supply brush 202 and the inner surface 63a of the brush holding portion 63 face each other in the rotation direction R, and the side surface 202d of the second anode power supply brush 202 and the inner surface 63b of the brush holding portion 63 face each other in the rotation direction R.

The rear end surface 202b of the second anode power supply brush 202 is planar and inclined to approach the outer circumferential surface of the commutator 45 from the side surface 202c, which is located at the front side of the second anode power supply brush 202 in the rotation direction R, toward the side surface 202d, which is located at the rear side of the second anode power supply brush 202 in the rotation direction R. The urging member 65, which urges the second anode power supply brush 202 toward the commutator 45, urges the rear end surface 202b toward the commutator 45. Since the urging member 65 urges the rear end surface 202b of the second anode power supply brush 202 toward the commutator 45, the vector of the urging force F of the urging member 65 is directed toward the front in the rotation direction R. More specifically, the vector of the urging force F is directed toward the front side of a line L2 in the rotation direction R. Further, the line L2 extends through the middle of the second anode power supply brush 202 in the rotation direction R and is orthogonal to the rotation direction R.

The operation of the present embodiment will now be described.

The rear end surface 202b of the second anode power supply brush 202 and the rear end surface 204b of the second cathode power supply brush 204 are each inclined to direct the vector of the urging force F produced by the urging member 65 toward the front in the rotation direction R. Thus, as illustrated in FIG. 23, when the urging member 65 urges the rear end surface 202b of the second anode power supply brush 202 toward the commutator 95, the component force Fa is produced in the rotation direction R to press the second anode power supply brush 202 toward the front in the rotation direction R. The second anode power supply brush 202, which is pressed by the component force Fa toward the front in the rotation direction R, presses the side surface 202c at the front side of the second anode power supply brush 202 in the rotation direction R against the inner surface 63a at the front side of the brush holding portion 63 in the rotation direction R. The second anode power supply brush 202 is movable in the direction orthogonal to the rotation direction R (direction from rear end of second anode power supply brush 202 toward distal end) while guided by the inner surface 63a at the front side of the brush holding portion 63 in the rotation direction R. The urging force F of the urging member 65 further produces a component force Fb in the direction orthogonal to the rotation direction R. Thus, the component force Fb presses the second anode power supply brush 202 against the outer circumferential surface of the commutator 45 (segment 48). As a result, the front end of the second anode power supply brush 202 in the rotation direction R, that is, the end separated from the segment 48, stably contacts the segment 48.

The second cathode power supply brush 204 has the same external shape as the external shape of the second anode power supply brush 202 and thus functions in the same manner as the second cathode power supply brush 204.

The present embodiment has advantages (12) to (14) of the eighth embodiment.

### Tenth Embodiment

A motor according to a tenth embodiment will now be described. Same reference numerals are given to those components that are the same as the corresponding components of the eighth embodiment. Such components will not be described in detail.

As illustrated in FIG. 29, the motor of the present embodiment includes a first anode power supply brush 211, instead of the first anode power supply brush 181 of the eighth embodiment, and a first cathode power supply brush 213, instead of the first cathode power supply brush 183 of the eighth embodiment. The width of each of the first anode power supply brush 211 and the first cathode power supply brush 213 in the rotation direction R is equal to the width of each of the second anode power supply brush 182 and the second cathode power supply brush 184 in the rotation direction R. Thus, in the present embodiment, the widths of all of the power supply brushes 182, 184, 211, and 213 are equal in the rotation direction R and equal to the width of each segment 48 in the rotation direction R. The power supply brushes 182, 184, 211, and 213 are arranged at equal angular intervals in the rotation direction R (intervals of 90 degrees in the present embodiment).

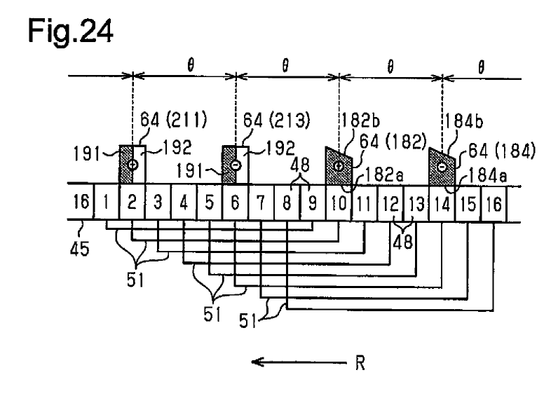

The first anode power supply brush 211 and the first cathode power supply brush 213 are configured to have an electric resistance that varies in the rotation direction R. More specifically, the first anode power supply brush 211 includes a high-resistance portion 191, which is defined by a portion of the first anode power supply brush 211 including a front end (left end in FIG. 24) in the rotation direction R, and the low-resistance portion 192, which is defined by a portion of the first anode power supply brush 211 excluding the high-resistance portion 191 and which has a smaller electric resistance than the high-resistance portion 191. In the same manner, the first cathode power supply brush 213 includes the high-resistance portion 191, which is defined by a portion of the first cathode power supply brush 213 including a front end in the rotation direction R, and the low-resistance portion 192, which is defined by a portion of the first cathode power supply brush 213 excluding the high-resistance portion 191 and which has a smaller electric resistance smaller than the high-resistance portion 191. In the present embodiment, the high-resistance portions 191 of the first anode power supply brush 211 and the first cathode power supply brush 213 each have an electric resistance that is equal to the electric resistance of the second anode power supply brush 182 and the second cathode power supply brush 184.

In each of the first anode power supply brush 211 and the first cathode power supply brush 213, the high-resistance portion 191 and the low-resistance portion 192 are arranged next to one another in the rotation direction R. The first anode power supply brush 211 and the first cathode power supply brush 213 each have a multilayer structure including the high-resistance portion 191 and the low-resistance portion 192 (two brush layers) that have different electric resistances and are overlapped with each other in the rotation direction R (i.e., laminate brush). The high-resistance portion 191 and the low-resistance portion 192 in the first anode power supply brush 211 and the first cathode power supply brush 213 have equal widths in the rotation direction R. Accordingly, the high-resistance portion 191 occupies one half of the volume of each of the first anode power supply brush 211 and the first cathode power supply brush 213. In the distal end surface of each of the first anode power supply brush 211 and the first cathode power supply brush 213, the high-resistance portion 191 occupies the front half in the rotation direction R, and the low-resistance portion 192 occupies the rear half in the rotation direction R. The cross-sectional shape of each of the first anode power supply brush 211 and the first cathode power supply brush 213 in a cross section orthogonal to the radial direction is uniform in the radial direction. The high-resistance portion 191 and the low-resistance portion 192 each have a quadrangular shape of the same size. The high-resistance portion 191 is formed by sintering a material of which the main component is carbon (C), and the low-resistance portion 192 is formed by sintering a material of which the main components are copper (Cu) and carbon (C).

The two power supply brushes 64 of the anode are arranged so that the middle of the second anode power supply brush 182 in the rotation direction R is located at the middle of the segment 48 in the rotation direction R that the second anode power supply brush 182 is presently in contact with when the middle of the first anode power supply brush 211 in the rotation direction R is located at the middle of the segment 48 in the rotation direction R that the first anode power supply brush 211 is presently in contact with. In the same manner, the two power supply brushes 64 of the cathode are arranged so that the middle of the second cathode power supply brush 184 in the rotation direction R is located at the middle of the segment 48 in the rotation direction R that the second cathode power supply brush 184 is presently in contact with when the middle of the first cathode power supply brush 213 in the rotation direction R is located at the middle of the segment 48 in the rotation direction R that the first cathode power supply brush 213 is presently in contact with. For example, as illustrated in FIG. 24, when the middle of the first anode power supply brush 211 in the rotation direction R is located at the middle of the number “2” segment 48 in the rotation direction R, the middle of the second anode power supply brush 182 in the rotation direction is located at the middle of the number “10” segment 48 in the rotation direction R. When the middle of the first cathode power supply brush 213 in the rotation direction R is located at the middle of the number “6” segment 48 in the rotation direction R, the middle of the second cathode power supply brush 184 in the rotation direction R is located at the middle of the number “14” segment 98 in the rotation direction R. All of the power supply brushes 64 are arranged to simultaneously come into contact with the segments 98 that are adjacent to the segments 48 that the power supply brushes 64 are presently in contact with. That is, the power supply brushes 64 are so arranged so that they all simultaneously come into contact with the subsequent segments 48.

In addition to the rear end surface 182b of the second anode power supply brush 182 and the rear end surface 184b of the second cathode power supply brush 184 functioning in the same manner as the eighth embodiment, the present embodiment operates in the manner described below.

In the motor of the present embodiment, the first anode power supply brush 211 and the second anode power supply brush 182, which have the same polarity, are simultaneously separated from segments 48 at which the potential is the same. In the same manner, the first cathode power supply brush 213 and the second cathode power supply brush 184, which have the same polarity, are simultaneously separated from the segments 48 at which the potential is the same. In this case, sparks may be produced at all of the power supply brushes 182, 184, 211, and 213 when separated from the segments 48. The sparks are produced at the front ends of the power supply brushes 182, 184, 211, and 213 in the rotation direction R when the power supply brushes 182, 184, 211, and 213 are separated from the segments 48 of the rotating commutator 45.

Each of the high-resistance portions 191, which are defined by portions including the front ends of the first anode power supply brush 211 and the first cathode power supply brush 213 in the rotation direction R, the second anode power supply brush 182, and the second cathode power supply brush 184 has a larger electric resistance than the low-resistance portions 192 of the first anode power supply brush 211 and the first cathode power supply brush 213. That is, the front end of each of the power supply brushes 182, 184, 211, and 213 in the rotation direction R has a larger electric resistance than the low-resistance portions 192. This reduces large sparks when the power supply brushes 182, 184, 211, and 213 are separated from the segments 48.

When the portion of the second anode power supply brush 182 that slides in contact with the segment 48 is cracked or when the second anode power supply brush 182 is loose, the first anode power supply brush 211 may be separated from a segments 48 at a later timing than the second anode power supply brush 182. In such a case, the front end of the first anode power supply brush 211 in the rotation direction R defining the high-resistance portion 191, which has a large electric resistance, reduces the generation of large sparks compared to when the entire first anode power supply brush 211 has an electric resistance equal to that of the low-resistance portion 192. Accordingly, wear caused by sparks is limited. In the same manner, when the second cathode power supply brush 184 that slides in contact with the segment 48 is cracked or when the second cathode power supply brush 184 is loose, the first cathode power supply brush 213 may be separated from the segments 48 at a later timing than the second cathode power supply brush 189. In such a case, the front end of the first cathode power supply brush 213 in the rotation direction R defining the high-resistance portion 191, which has a large electric resistance, reduces the generation of large sparks compared to when the entire first cathode power supply brush 213 has an electric resistance equal to that of the low-resistance portion 192. Accordingly, wear caused by sparks is limited.

The advantages of the present embodiment will now be described.

(15) When the power supply brushes 182, 184, 211, and 213 are separated from the segments 48 of the rotating commutator 45, sparks are produced at the front ends of the power supply brushes 182, 184, 211, and 213 in the rotation direction R, that is, at the ends separated from the segments 48. The rear end surface 182b of the second anode power supply brush 182 and the rear end surface 184b of the second cathode power supply brush 184 are each inclined to direct the vector of the urging force F produced by the urging member 65 toward the front in the rotation direction R. In this case, the second anode power supply brush 182 and the second cathode power supply brush 184 are each pressed against the brush holding portion 63 toward the front in the rotation direction R by the urging force F of the urging member 65 (component force Fa). Thus, loosening of the front ends of the second anode power supply brush 182 and the second cathode power supply brush 184 in the rotation direction R is limited during rotation of the commutator 45. This limits separation of the first anode power supply brush 211 from the segment 48 at a later timing than the second anode power supply brush 182 that would be caused by loosening of the second anode power supply brush 162. This also limits separation of the first cathode power supply brush 213 from the segment 48 at a later timing than the second cathode power supply brush 184 that would be caused by loosening of the second cathode power supply brush 184. As a result, among the plurality of power supply brushes 64, the generation of sparks is reduced at the first anode power supply brush 211 and the first cathode power supply brush 213 that include the low-resistance portions 192 having a smaller electric resistance than the second anode power supply brush 182 and the second cathode power supply brush 184. This limits the shortening of the life of the first anode power supply brush 211 and the first cathode power supply brush 213, which include the low-resistance portions 192 having a smaller electric resistance than the second anode power supply brush 182 and the second cathode power supply brush 184.

(16) The first anode power supply brush 211 and the second anode power supply brush 182 of the anode have equal widths in the rotation direction R. In addition, the first anode power supply brush 211 and the second anode power supply brush 182 simultaneously contact the segments 48 adjacent to the segments 48 that the first anode power supply brush 211 and the second anode power supply brush 182 are presently in contact with.

Accordingly, the first anode power supply brush 211 and the second anode power supply brush 182 are simultaneously separated from the segments 48. In the same manner, the first cathode power supply brush 213 and the second cathode power supply brush 184 of the cathode have equal widths in the rotation direction R. In addition, the first cathode power supply brush 213 and the second cathode power supply brush 184 simultaneously contact the segments 48 adjacent to the segments 48 that the first cathode power supply brush 213 and the second cathode power supply brush 184 are presently in contact with. Accordingly, the first cathode power supply brush 183 and the second cathode power supply brush 184 are simultaneously separated from the segments 48. The first anode power supply brush 211 and the first cathode power supply brush 213, which include the low-resistance portions 192 having a smaller electric resistance than the second anode power supply brush 182 and the second cathode power supply brush 184, includes the high-resistance portion 191 having a larger electric resistance than the low-resistance portion 192 and located at the front end of the first anode power supply brush 211 or the first cathode power supply brush 213 in the rotation direction R when separated from the segments 48. This reduces the generation of large sparks when the first anode power supply brush 181 and the first cathode power supply brush 183 are separated from the segments 48. This limits the shortening of the life of the first anode power supply brush 211 and the first cathode power supply brush 213 resulting from spark wear even when the first anode power supply brush 211 and first cathode power supply brush 213, which include the low-resistance portions 192, and the second anode power supply brush 182 and second cathode power supply brush 189, which have a larger electric resistance than the low-resistance portions 192, are simultaneously separated from the segments 48.

(17) The low-resistance portions 192 of the first anode power supply brush 211 and the first cathode power supply brush 213 each have a smaller electric resistance than the second anode power supply brush 182 and the second cathode power supply brush 184. This limits increases in the electrical losses of the first anode power supply brush 211 and the first cathode power supply brush 213. Accordingly, decreases in the output of the motor are limited in comparison with when the power supply brushes 64 all formed by high-resistance power supply brushes.

(18) Not all of the power supply brushes 64 are formed by power supply brushes having an electric resistance that varies in the rotation direction R like the first anode power supply brush 211 and the first cathode power supply brush 213. This facilitates manufacturing of the power supply brushes 64 without increasing the manufacturing costs of the power supply brushes 64 in comparison with a structure in which the electric resistance of all of the power supply brushes are varied in the rotation direction of the commutator.

### Eleventh Embodiment

A motor according to an eleventh embodiment will now be described. Same reference numerals are given to those components that are the same as the corresponding components of the eighth embodiment. Such components will not be described in detail.

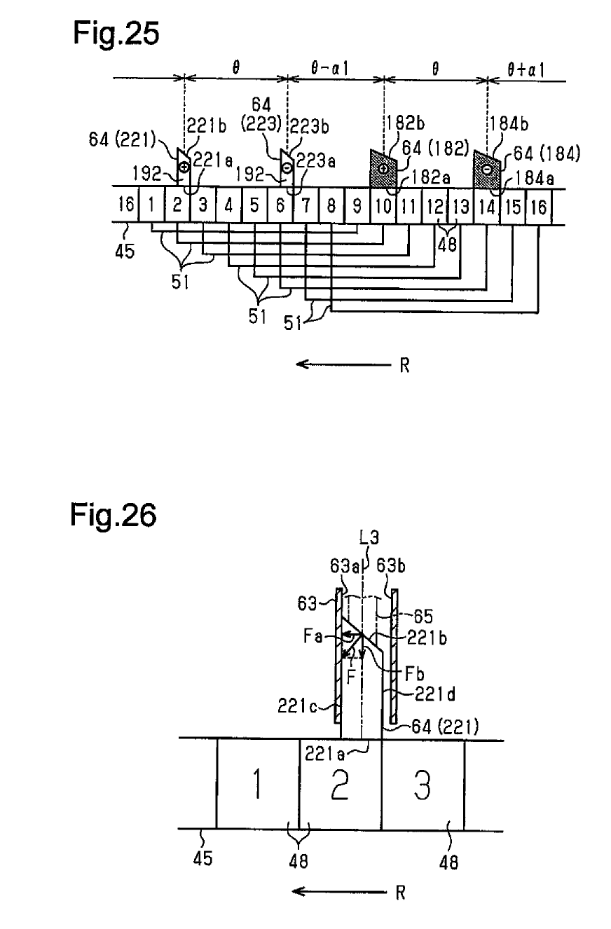

As illustrated in FIG. 25, a first anode power supply brush 221 of the present embodiment differs from the first anode power supply brush 181 of the eighth embodiment in the shape of the rear end. Further, a first cathode power supply brush 223 of the present embodiment differs from the first cathode power supply brush 183 of the eighth embodiment in the shape of the rear end.

As illustrated in FIGS. 25 and 26, a rear end surface 221b of the first anode power supply brush 221 (end surface at side opposite to distal end surface 221a that contacts commutator 45) and a rear end surface 223b of the first cathode power supply brush 223 (end surface at side opposite to distal end surface 223a that contacts commutator 45) are each inclined to direct the vector of the urging force F produced by the urging member 65 toward the front in the rotation direction R. The first cathode power supply brush 223 has the same external shape as the external shape of the first anode power supply brush 221. Accordingly, the shape of only the first anode power supply brush 221 will be described, and the shape of the first cathode power supply 223 will not be described.

Two side surfaces 221c and 221d of the first anode power supply brush 221 in the rotation direction R extend parallel to each other. The two side surfaces 221c and 221d of the first anode power supply brush 221 are parallel to the diametrical direction of the commutator 45 as viewed in the axial direction of the rotation shaft 42 (see FIG. 1). The brush holding portion 63 accommodating the first anode power supply brush 221 includes the two inner surfaces 63a and 63b facing each other in the rotation direction R and spaced apart by a distance that is slightly greater than the width of the first anode power supply brush 221 in the rotation direction R. Inside the brush holding portion 63, the side surface 221c of the first anode power supply brush 221 and the inner surface 63a of the brush holding portion 63 face each other in the rotation direction R, and the side surface 221d of the first anode power supply brush 221 and the inner surface 63b of the brush holding portion 63 face each other in the rotation direction R.

The rear end surface 221b of the first anode power supply brush 221 is planar and inclined to approach the outer circumferential surface of the commutator 45 from the side surface 221c, which is located at the front side of the first anode power supply brush 221 in the rotation direction R, toward the side surface 221d, which is located at the rear side of the first anode power supply brush 221 in the rotation direction R. The urging member 65, which urges the first anode power supply brush 221 toward the commutator 45, urges the rear end surface 221b toward the commutator 45. Since the urging member 65 urges the rear end surface 221b of the first anode power supply brush 221 toward the commutator 45, the vector of the urging force F of the urging member 65 is directed toward the front in the rotation direction R. More specifically, the vector of the urging force F is directed toward the front side of a line L3 in the rotation direction R. The line L3 extends through the middle of the first anode power supply brush 221 in the rotation direction R and is orthogonal to the rotation direction R.

In addition to operating as described in the eighth embodiment, the present embodiment operates as described below.

The rear end surface 221b of the first anode power supply brush 221 and the rear end surface 223b of the first cathode power supply brush 223 are each inclined to direct the vector of the urging force F produced by the urging member 65 toward the front in the rotation direction R. Thus, as illustrated in FIG. 26, when the urging member 65 urges the rear end surface 221b of the first anode power supply brush 221 toward the commutator 45, the component force Fa is produced in the rotation direction R to press the first anode power supply brush 221 toward the front in the rotation direction R. The first anode power supply brush 221 pressed by the component force Fa toward the front in the rotation direction R presses the side surface 221c at the front side of the first anode power supply brush 221 in the rotation direction R against the inner surface 63a at the front side of the brush holding portion 63 in the rotation direction R. The first anode power supply brush 221 is movable in the direction orthogonal to the rotation direction R (direction from rear end of first anode power supply brush 221 toward distal end) while guided by the inner surface 63a at the front side of the brush holding portion 63 in the rotation direction R. The urging force F of the urging member 65 further produces the component force Fb in the direction orthogonal to the rotation direction R. In this case, the component force Fb presses the first anode power supply brush 221 against the outer circumferential surface of the commutator 45 (segment 48). As a result, the front end of the first anode power supply brush 221 in the rotation direction R, that is, the end separated from the segment 48, stably contacts the segment 48.

The first cathode power supply brush 223 has the same external shape as the external shape of the first anode power supply brush 221. Thus, the first cathode power supply brush 223 functions in the same manner.

In addition to advantages (12) to (14) of in the eighth embodiment, the present embodiment has the advantages described below.

(19) The rear end surface of all of the power supply brushes 64, that is, the rear end surface 221b of the first anode power supply brush 221, the rear end surface 182b of the second anode power supply brush 182, the rear end surface 223b of the first cathode power supply brush 223, and the rear end surface 184b of the second cathode power supply brush 184 are inclined to direct the vector of the urging force F produced by the corresponding urging member 65 toward the front in the rotation direction R. In this case, the urging force F of the urging member 65 presses each of the power supply brushes 182, 184, 221, and 223 against the brush holding portion 63 toward the front in the rotation direction R. This limits loosening of all of the power supply brushes 182, 184, 221, and 223 during rotation of the commutator 45. Thus, separation of the first anode power supply brush 221 from the segment 48 at a later timing than the second anode power supply brush 182 and separation of the first cathode power supply brush 223 from the segment 48 at a later timing than the second cathode power supply brush 184 are limited. As a result, the generation of sparks is reduced at the first anode power supply brush 221 and the first cathode power supply brush 223 that have a smaller electric resistance than the second anode power supply brush 182 and the second cathode power supply brush 184. Moreover, the generation of noise is reduced that would be caused by loosening of the power supply brushes 182, 184, 221, and 223.

(20) The rear end surface 221b of the first anode power supply brush 221 and the rear end surface 223b of the first cathode power supply brush 223 are each inclined to direct the vector of the urging force F produced by the urging member 65 toward the front in the rotation direction R. Thus, the urging force F of the urging member 65 presses the first anode power supply brush 221 and the first cathode power supply brush 223, which allow a larger current to flow to the segments 48 than the second anode power supply brush 182 and the second cathode power supply brush 184, against the brush holding portion 63 toward the front in the rotation direction R. The rear end of the first anode power supply brush 221 and the first cathode power supply brush 223 in the rotation direction R (i.e., end separated from segment 48) therefore contacts the segment 48 in a further stable manner. Accordingly, loosening of the first anode power supply brush 221 and the first cathode power supply brush 223 is further limited.

### Twelfth Embodiment

A motor according to a twelfth embodiment will now be described. Same reference numerals are given to those components that are the same as the corresponding components of the eighth and eleventh embodiment. Such components will not be described in detail.

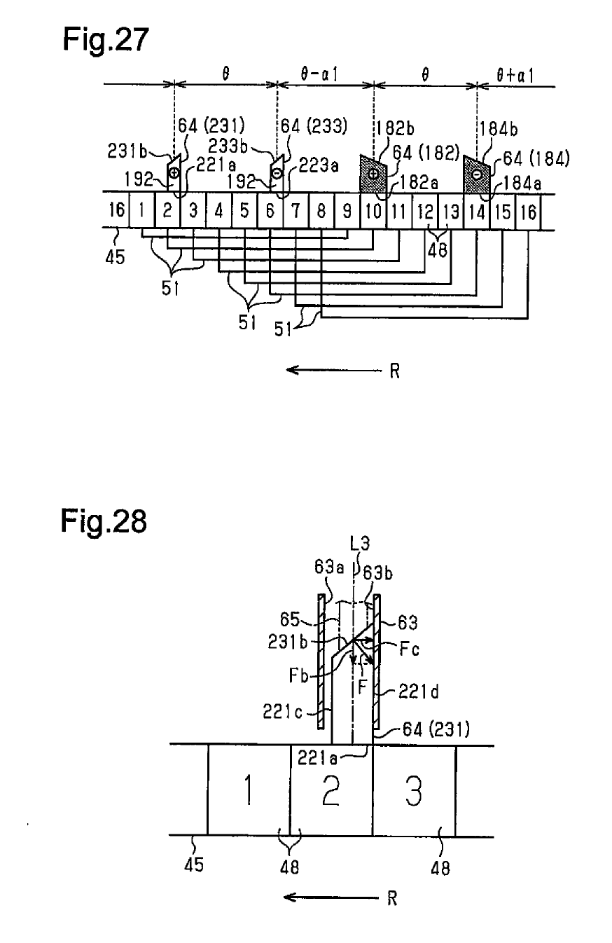

As illustrated in FIG. 27, a first anode power supply brush 231 of the present embodiment differs from the first anode power supply brush 221 of the eleventh embodiment in the shape of the rear end. In the same manner, a first cathode power supply brush 233 of the present embodiment is differs from the first cathode power supply brush 223 of the eleventh embodiment in the shape of the rear end.

As illustrated in FIGS. 27 and 28, a rear end surface 231b of the first anode power supply brush 231 (end surface at side opposite to distal end surface 221a that contacts commutator 45) and a rear end surface 233b of the first cathode power supply brush 233 (end surface at side opposite to distal end surface 223a that contacts commutator 45) is inclined to direct the vector of the urging force F produced by the urging member 65 toward the rear in the rotation direction R. The first cathode power supply brush 233 has the same external shape as the external shape of the first anode power supply brush 231. Thus, only the shape of the first anode power supply brush 231 will be described, and the shape of the first cathode power supply 233 will not be described.

The rear end surface 231b of the first anode power supply brush 231 is planar and inclined to approach the outer circumferential surface of the commutator 45 from the side surface 221d, which is located at the rear side of the first anode power supply brush 231 in the rotation direction R, toward the side surface 221c, which is located at the front side of the first anode power supply brush 231 in the rotation direction R. The urging member 65, which urges the first anode power supply brush 231 toward the commutator 45, urges the rear end surface 231b toward the commutator 45. Since the urging member 65 urges the rear end surface 231b of the first anode power supply brush 231 toward the commutator 45, the vector of the urging force F of the urging member 65 is directed toward the rear in the rotation direction R. More specifically, the vector of the urging force F is directed toward the rear side of the line L3 in the rotation direction R. The line L3 extends through the middle of the first anode power supply brush 231 in the rotation direction R and is orthogonal to the rotation direction R.

In addition to operating as described in the eighth embodiment, the present embodiment operates as described below.

The rear end surface 231b of the first anode power supply brush 231 and the rear end surface 233b of the first cathode power supply brush 233 are each inclined to direct the vector of the urging force F produced by the urging member 65 toward the rear in the rotation direction R. Thus, as illustrated in FIG. 28, when the urging member 65 urges the rear end surface 231b of the first anode power supply brush 231 toward the commutator 45, the component force Fc is produced in the rotation direction R to press the first anode power supply brush 231 toward the rear in the rotation direction R. The first anode power supply brush 231 pressed by the component force Fc toward the rear in the rotation direction R presses the side surface 221d at the rear side of the first anode power supply brush 231 in the rotation direction R against the inner surface 63b at the rear side of the brush holding portion 63 in the rotation direction R. The first anode power supply brush 231 is movable in the direction orthogonal to the rotation direction R (direction from rear end of first anode power supply brush 231 toward distal end) while guided by the inner surface 63b at the rear side of the brush holding portion 63 in the rotation direction R. The urging force F of the urging member 65 further produces the component force Fb in a direction orthogonal to the rotation direction R. Thus, the component force Fb presses the first anode power supply brush 231 against the outer circumferential surface of the commutator 45 (segment 48). As a result, the rear end of the first anode power supply brush 231 in the rotation direction R, that is, the end that starts contact with the subsequent segment 48, contacts the segment 48 in a stable manner.

The first cathode power supply brush 233 has the same external shape as the external shape of the first anode power supply brush 231. Thus, the first cathode power supply brush 233 operates in the same manner.

In addition to advantages (12) to (14) of the eighth embodiment, the present embodiment has the advantages described below.

(21) The rear end surface 231b of the first anode power supply brush 231 and the rear end surface 233b of the first cathode power supply brush 233 are each inclined to direct the vector of the urging force F produced by the urging member 65 toward the rear in the rotation direction R. Thus, the urging force F of the urging member 65 presses each of the power supply brushes 231 and 233 against the brush holding portion 63 toward the rear in the rotation direction R. The rear end surface 182b of the second anode power supply brush 182 and the rear end surface 184b of the second cathode power supply brush 184 are each inclined to direct the vector of the urging force F produced by the urging member 65 toward the front in the rotation direction R. In this case, the urging force F of the urging member 65 presses each of the power supply brushes 182 and 184 against the brush holding portion 63 toward the front in the rotation direction R. Accordingly, loosening is limited in all of the power supply brushes 182, 189, 231, and 233 during rotation of the commutator 45. This limits separation of the first anode power supply brush 231 from the segment 48 at a timing later than the second anode power supply brush 182 and limits separation of the first cathode power supply brush 233 from the segment 48 at a timing later than the second cathode power supply brush 184. As a result, the generation of sparks is further reduced at the first anode power supply brush 231 and the first cathode power supply brush 233 each that have a smaller electric resistance than the second anode power supply brush 182 and the second cathode power supply brush 184. Moreover, the generation of noise is reduced that would be caused by loosening of the power supply brushes 182, 184, 231, and 233.

(22) The rear end surface 231b of the first anode power supply brush 231 and the rear end surface 233b of the first cathode power supply brush 233 are each inclined to direct the vector of the urging force F produced by the urging member 65 toward the rear in the rotation direction R. Thus, the urging force F of the urging member 65 presses the first anode power supply brush 231 and the first cathode power supply brush 233, which allow a larger current to flow to the segments 48 than the second anode power supply brush 182 and the second cathode power supply brush 184, against the brush holding portion 63 toward the rear in the rotation direction R. This stabilizes the state of contact between the subsequent segment 48 and the rear end of each of the first anode power supply brush 231 and the first cathode power supply brush 233 in the rotation direction R. (i.e., end that starts contact with subsequent segment 48 when switching segments 48). Accordingly, loosening of the first anode power supply brush 231 and the first cathode power supply brush 233 is further limited. As a result, contact resistance is decreased between the segments 48 and the rear ends of the first anode power supply brush 231 and the first cathode power supply brush 233 in the rotation direction R. This further reduces wear of the first anode power supply brush 231 and the first cathode power supply brush 233, which, in turn, further limits shortening of the life of the first anode power supply brush 231 and the first cathode power supply brush 233.

The above embodiments may be modified as described below.

The proportion of the high-resistance portions 191 in the volumes of the first anode power supply brush 211 and the first cathode power supply brush 213 is not limited to that of the tenth embodiment and may be changed.

In the tenth embodiment, the electric resistance of the second anode power supply brush 182 and the second cathode power supply brush 184 is equal to that of the high-resistance portions 191. However, the electric resistance of the second anode power supply brush 182 and the second cathode power supply brush 184 may different from that of the high-resistance portions 191. For example, the electric resistance of the high-resistance portions 191 may be larger than that of the second anode power supply brush 182 and the second cathode power supply brush 184. In this case, the electric resistance of the second anode power supply brush 182 and the second cathode power supply brush 184 differs from the electric resistance of the high-resistance portions 191 by changing the sintering time, for example. As a result, the second anode power supply brush 182 and the second cathode power supply brush 184 have a smaller electric resistance than the high-resistance portions 191 of the first anode power supply brush 211 and the first cathode power supply brush 213. Accordingly, current also flows to the second anode power supply brush 182 and the second cathode power supply brush 184 in contrast with when the electric resistance of the second anode power supply brush 182 and the second cathode power supply brush 184 is equal to the electric resistance of the high-resistance portions 191. In addition, the flow of a large current is limited in the low-resistance portions 192 that have a smaller electric resistance than the high-resistance portions 191 in the first anode power supply brush 211 and the first cathode power supply brush 213. This further limits the shortening of the life of the first anode power supply brush 211 and the first cathode power supply brush 213. In this case, the electric resistance of the second anode power supply brush 182 and the second cathode power supply brush 184 is larger than the electric resistance of the low-resistance portions 192 of the first anode power supply brush 211 and the first cathode power supply brush 213. This limits the generation of large sparks at the second anode power supply brush 182 and the second cathode power supply brush 184 when the second anode power supply brush 182 and the second cathode power supply brush 184 are separated from the segments 48.

In the tenth embodiment, each of the first anode power supply brush 221 and the first cathode power supply brush 213 has a laminate structure that includes the two brush layers of the high-resistance portion 191 and the low-resistance portion 192 overlapped with each other in the rotation direction R. However, the number of the brush layers in each of the power supply brushes 211 and 213 is not limited. For example, each of the first anode power supply brush 211 and the first cathode power supply brush 213 may be formed by three brush layers that include the two high-resistance portions 191, which are arranged at the two ends in the rotation direction R, and the low-resistance portion 192, which is arranged between the two high-resistance portions 191.

In the tenth embodiment, the high-resistance portion 191 is formed by sintering a material of which the main component is carbon (C), and the low-resistance portion 192 is formed by sintering a material of which the main components are copper (Cu) and carbon (C). However, the materials of the high-resistance portion 191 and the low-resistance portion 192 are not limited. The high-resistance portion 191 and the low-resistance portion 192 may be formed from any material as long as the electric resistance of the low-resistance portion 192 is smaller than the electric resistance of the high-resistance portion 191. The low-resistance portions 192 are formed to that the electric resistance is smaller than the second anode power supply brush 182 and the second cathode power supply brush 184.

In the eighth embodiment, the motor 31 includes a total of four power supply brushes, namely, the two power supply brushes 64 of the anode (first anode power supply brush 181 and second anode power supply brush 182) and the two power supply brushes 64 of the cathode (first cathode power supply brush 183 and second cathode power supply brush 184). However, the motor 31 may include any number of power supply brushes 64 as long as either one of the anode and the cathode includes a plurality of poles. The same applies to the motors of the ninth to twelfth embodiments. For example, the second cathode power supply brush 184 may be omitted from the motor 31 of the eighth embodiment. This reduces the number of the power supply brushes 64 and lowers the manufacturing cost of the motor. Further, the reduced number of components facilitates the coupling of the power supply brushes 64.

In the eighth, ninth, eleventh, and twelfth embodiments, the first anode power supply brushes 181, 201, 221, and 231 and the first cathode power supply brushes 183, 203, 223, and 233 are formed by sintering a material of which the main components are copper (Cu) and carbon (C). Further, the second anode power supply brushes 182 and 202 and the second cathode power supply brushes 184 and 204 are formed by sintering a material of which the main component is carbon (C). However, the first anode power supply brushes 181, 201, 221, 231, the first cathode power supply brushes 183, 203, 223, and 233, the second anode power supply brushes 182 and 202, and the second cathode power supply brushes 184 and 204 are not limited to these materials. The first anode power supply brushes 181, 201, 221, and 231 and the second anode power supply brushes 182 and 202 may be formed from any material as long as the electric resistance of the first anode power supply brushes 181, 201, 221, and 231 is smaller than the electric resistance of the second anode power supply brushes 182 and 202. In the same manner, the first cathode power supply brushes 183, 203, 223, and 233 and the second cathode power supply brushes 184 and 204 may be formed from any material as long as the electric resistance of the first cathode power supply brushes 183, 203, 223, and 233 is smaller than the electric resistance of the second cathode power supply brushes 184 and 204.

The first anode power supply brushes 181, 201, 211, 221, and 231, the first cathode power supply brushes 183, 203, 213, 223, and 233, the second anode power supply brushes 182 and 202, and the second cathode power supply brushes 184 and 204 are not limited to the widths and the positions relative to the rotation direction R as described in the above embodiments and may be changed. However, the first anode power supply brushes 181, 201, 211, 221, and 231, and the second anode power supply brushes 182 and 202 of the same polarity are configured to be simultaneously separated from the segments 48 or so that the second anode power supply brushes 182 and 202 are separated from the segments 48 at a later timing than the first anode power supply brushes 181, 201, 211, 221, and 231. In the same manner, the first cathode power supply brushes 183, 203, 213, 223, and 233, and the second cathode power supply brushes 184 and 204 of the same polarity are configured to be simultaneously separated from the segments 48 or so that the second cathode power supply brushes 184 and 204 are separated from the segments 48 at a later timing than the first cathode power supply brushes 183, 203, 213, 223, and 233.

The urging member 65 in the above embodiments is a compression coil spring. However, the urging member 65 is not limited to a compression coil spring as long as it can urge the power supply brush 64 toward the commutator 45. For example, the urging member 65 may be a torsion coil spring.

The brush holding portions 63 that hold the power supply brushes 64 does not have to be configured as described in the above embodiments. For example, the brush holding portions 63 may be formed from a resin material integrally with the base member 62.

The numbers of the segments 48, the coils 44, and the poles of the magnets 33 in the embodiments may be changed.

The embodiments and modified examples may be combined with one another.

### DESCRIPTION OF REFERENCE CHARACTERS

31, 131, 151) motor; 44, 135, 155) coil; 45, 134, 154) commutator; 46) segment; 51) short-circuiting member; 64) power supply brush; 81, 101, 111, 121, 141a, 141b) first anode power supply brush serving as first power supply brush; 82, 112, 142) second anode power supply brush serving as second power supply brush; 83, 103, 113, 123, 143a, 143b) first cathode power supply brush serving as first power supply brush; 84, 114, 144) second cathode power supply brush serving as second power supply brush; 91) high-resistance portion; 92) low-resistance portion; R) rotation direction; 61) brush holder; 63) brush holding portion; 65) urging member; 181, 201, 211, 221, 231) first anode power supply brush serving as first power supply brush; 182, 202) second anode power supply brush serving as second power supply brush; 182b, 184b, 202b, 204b) rear end surface; 183, 203, 213, 223, 233) first cathode power supply brush serving as first power supply brush; 184, 204) second cathode power supply brush serving as second power supply brush; 192) low-resistance portion; 221b, 223b, 231b, 233b) rear end surface; F) urging force

1. A motor comprising:
a commutator rotated in a circumferential direction, wherein the commutator includes a plurality of segments and a short-circuiting member, the plurality of segments are arranged next to each other in the circumferential direction, a plurality of coils are respectively connected to the plurality of segments, and the short-circuiting member short-circuits the segments at which potential is the same; and
a plurality of power supply brushes that sequentially slide in contact with the plurality of segments, wherein
the plurality of power supply brushes are at least either one of a plurality of anode power supply brushes and a plurality of cathode power supply brushes,
at least one of the plurality of power supply brushes is a first power supply brush having an electric resistance that varies in a rotation direction of the commutator, and at least a remaining one of the plurality of power supply brushes is a second power supply brush that has a constant electric resistance in the rotation direction of the commutator,
the first power supply brush includes a high-resistance portion that is defined by a portion that includes a front end of the first power supply brush in the rotation direction of the commutator and a low-resistance portion that is arranged next to the high-resistance portion in the rotation direction of the commutator and has a smaller electric resistance than the high-resistance portion, and
the second power supply brush has a larger electric resistance than the low-resistance portion.

2. The motor according to claim 1, wherein the first power supply brush has a multilayer structure that includes a plurality of brush layers having different electric resistances and overlapped with each other in the rotation direction of the commutator.

3. The motor according to claim 1, wherein the high-resistance portion has a larger electric resistance than the second power supply brush.

4. The motor according to claim 1, wherein a middle of the second power supply brush in the rotation direction of the commutator is located at a middle of the segment on which the second power supply brush is sliding in contact with in the rotation direction of the commutator when a middle of the first power supply brush in the rotation direction of the commutator is located at a middle of the segment on which the first power supply brush is sliding in contact with in the rotation direction of the commutator.

5. The motor according to claim 1, wherein at least either one of the plurality of anode power supply brushes and the plurality of cathode power supply brushes have equal widths in the rotation direction of the commutator.

6. The motor according to claim 1, wherein at least either one of the plurality of anode power supply brushes and the plurality of cathode power supply brushes simultaneously come into contact with the segments that are adjacent to the segments on which the power supply brushes are presently sliding in contact with.

7. The motor according to claim 1, wherein the first power supply brush includes two of the high-resistance portions that are located at two ends of the first power supply brush in the rotation direction of the commutator and the low-resistance portion that is located between the two high-resistance portions.

8. The motor according to claim 1, wherein the first power supply brush and the second power supply brush of the same polarity are arranged so that the second power supply brush is separated from the segment later than the first power supply brush.

9. The motor according to claim 1, wherein a proportion of the first power supply brush occupied by the high-resistance portion is less than or equal to one half.

10. A motor comprising:
a commutator rotated in a circumferential direction, wherein the commutator includes a plurality of segments and a short-circuiting member, the plurality of segments are arranged next to each other in the circumferential direction, a plurality of coils are respectively connected to the plurality of segments, and the short-circuiting member short-circuits the segments at which potential is the same;
a plurality of power supply brushes including distal ends that sequentially slide in contact with the plurality of segments;
a brush holder that includes a plurality of brush holding portions respectively accommodating the plurality of power supply brushes; and
a plurality of urging members that respectively urge rear end surfaces of the plurality of power supply brushes toward the commutator, wherein
the plurality of power supply brushes are at least either one of a plurality of anode power supply brushes and a plurality of cathode power supply brushes,
at least one of the plurality of power supply brushes of the same polarity is a first power supply brush that partially or entirely defines a low-resistance portion arranged in the rotation direction of the commutator, and a remaining one of the plurality of power supply brushes is a second power supply brush that has a larger electric resistance than the low-resistance portion,
the first power supply brush and the second power supply brush of the same polarity are simultaneously separated from the segments or the second power supply brush is separated from the segment later than the first power supply brush, and
a rear end surface of the second power supply brush is inclined to direct a vector of an urging force produced by the corresponding urging member toward a front side in the rotation direction of the commutator.

11. The motor according to claim 10, wherein the power supply brushes all include a rear end surface that is inclined to direct a vector of an urging force produced by the corresponding urging member toward either one of a front side or a rear side in the rotation direction of the commutator.

12. The motor according to claim 11, wherein the rear end surface of the first power supply brush is inclined to direct the vector of the urging force produced by the corresponding urging member toward the rear side in the rotation direction of the commutator.

13. The motor according to claim 11, wherein the rear end surface of the first power supply brush is inclined to direct the vector of the urging force produced by the corresponding urging member toward the front side in the rotation direction of the commutator.

14. The motor according to claim 10, wherein the first power supply brush entirely defines a low-resistance portion in the rotation direction of the commutator and has an electric resistance that is constant in the rotation direction of the commutator.
